(19) United States
(12) Patent Application Publication
(10) Pub. No.: US 2003/0182163 A1
(43) Pub. Date: Sep. 25, 2003

(54) System for patient intervention assistance and evaluation

(76) Inventors: Bradley P. Tice, Urbandale, IA (US); Todd A. Viegut, West Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/082,757

(22) Filed: Feb. 25, 2002

(51) Int. Cl. G06F 17/60

(52) U.S. Cl. 705/3

(57) ABSTRACT

The present invention relates to an apparatus, method, and system that provides a personal, portable module that can be used by a pharmacist, pharmacy student, or pharmacy preceptor to more effectively practice. It can be usable by others, including other types of healthcare practitioners. The module is preferably hand-portable and has both input and output features. It can be communicated to another device. It includes software which integrates several practice functions and allows data transfer, both to another device for further use or to the portable module for point of care use. In one aspect of the invention, the system establishes a mechanism to assess the level of cognitive complexity of patient interventions performed by students or practitioners. Another aspect of the invention involves automatic documentation of the intervention. In another aspect of the invention, the system enables data entry and the capture of drug-related problem intervention information, enables treatment guidelines to be incorporated into the point of care.

### BACKGROUND OF THE INVENTION

A. Field of Invention

This invention relates to an apparatus and method for assisting in a healthcare practitioner's practice or education, and in particular, patient interventions. It can operate on personal digital assistant (PDA) devices and/or personal computing devices and assists in the recording of patient interventions performed by healthcare practitioners and students. Optionally, it also can incorporate recommended guidelines into the point of care, establish a method of assessing the cognitive ability required to perform the intervention, and allow the transfer of data from remote locations to a central database.

B. Problems in the Art

Patient interventions relate to a healthcare practitioner's involvement with a patient's medical condition. Depending on the type of practitioner and patient/condition, the kind and degree of involvement varies. The practitioner uses training/experience in taking action(s) in the intervention. There are a number of factors, some conflicting or competing, that determine the level of involvement of the practitioner in the intervention.

An example in the healthcare field is pharmacists. Pharmacists are a critical part of health care delivery. Increasing complexity and variety of medications, utilization/number of prescriptions concurrently taking, both over-the-counter and prescription, require their involvement and expertise. The public and the health care field rely on the same.

Pharmaceuticals can range from those that pose little danger, even if improperly used, to those that can cause serious harm or death. For example, some medicines are toxic or contain potentially toxic substances. Without proper preparation, dispensation, and/or instruction, even authorized usage can be dangerous.

New medicines emerge constantly and intelligence about existing medicines continues to increase, such that new protocols for new or existing medicines are found to be effective to treat certain health problems.

The pharmacist is centrally involved in these matters. It is not overstatement to acknowledge these can be life and death issues. Therefore, there is a continual need to educate and enable pharmacists to deal with this increasingly complex field. There is also a continual need to minimize the chance for errors with respect to pharmaceuticals and their use.

Pharmacists perform a variety of functions. They can be essentially distributors of pharmaceuticals, with minimal involvement in decisions about which medicines to use, dosages, modifications, etc. This is a common view of pharmacists by some. But they are involved to a higher degree than simply filling a prescription ordered by a physician.

For example, clinical pharmacists are routinely consulted by physicians and/or patients. They monitor a patient's progress and suggest modifications. Many pharmacists in private practice routinely de facto provide at least some of this assistance, which will generally be referred to as “patient intervention” in the process of providing drug therapy to patients/clients.

It has been predicted that the amount and level of intervention by pharmacists will dramatically increase in the future. See Hepler, C. D. and Strand, L. M. Opportunities and Responsibilities in Pharmaceutical Care. M. J. Hosp. Pharm. 1990; 47:533-43. The profession of pharmacy has been transitioning from a product-based business to a service-based business for approximately 12 years. Id. The main premise in this is for pharmacists to identify and resolve drug therapy problems. The transition has been somewhat slow. Some of the reasons for this include an inability to establish the value of such services, an inability to consistently deliver such services, and increased time pressures due to increasing prescription volume and decreasing reimbursement as a result of managed care.

Increased patient intervention makes even more important the need for better education and practice training and tools to prepare for this new paradigm in pharmacist practice. To invest newly graduating pharmacists with the capabilities of this new standard of practice, schools and colleges of pharmacy have instituted the principles of “pharmaceutical care” (Hepler and Strand, supra) and have students develop these skills through their schooling; especially in their last year of formal education.

Currently, pharmacy students in their last year of schooling go on “rotations” where they gain practical experience by rotating through various practice or rotation sites. During these rotations they perform actual patient interventions under the supervision of pharmacists and pharmacy college faculty where they identify and resolve drug therapy problems. These interventions are typically recorded on paper and then are either presented in case study discussions or reviewed by faculty. Some schools are also beginning to incorporate database systems. The students can take their paper notes and input them into a web-based form for data collection and faculty review.

Currently, only about ⅓ of these rotations are done directly with college faculty. Because of the number of pharmacy students in relation to the number of faculty and the limited number of faculty practice sites, students are not always on a rotation with a university or college professor. Thus, schools typically rely on volunteer practitioners to serve as adjunct faculty and oversee students on rotations. This can be approximately two-thirds of the rotations the students participate in.

One of a college's primary concerns for these sites is maintaining quality and assuring good learning experiences. Prior to this invention, the primary mechanism colleges have had to accomplish this is through spot-checks of the rotation sites, the provision of reference materials, and inviting adjunct faculty in for training.

Therefore, the present state of the art in pharmaceutical colleges for training intervention involves case studies, one by one. Documentation is predominantly handwritten. Review is made of the handwritten documentation, with perhaps, personal conferences with the reviewer. The reviewer must then assess the documentation and grade the student. Typically only one or two a week are reviewed because of time constraints.

This process is time-consuming and cumbersome. It has limitations because of limitations in resources. As indicated above, on the order of two-thirds of these case studies may be with someone other than a college professor. These types of resource problems conflict with the provision of a good, focused education on patient intervention to attempt to face these new challenges in the pharmacist's world.

Other sometimes-conflicting pressures exist in the pharmacist's field of endeavor. Medication errors make up a significant health care problem in today's society (See, e.g., Kohn, L. T., Dorrigan, J. M., Donaldson, M. S., To Err is Human: Building a Safer Health System. Institute of Medicine. National Academy Press, Washington, D.C, 2000). Minimization and deterrence of errors is always a dominating goal in this profession. But potential for errors is likely amplified or expanded in scope with increased patient intervention by pharmacists. More intervention may result in more, and different types of, pharmacist service. More service usually means more time involved. And, for each pharmacist, more time per patient means less time for other patients and duties. But managed care constantly tries to limit the amount of compensation for services, which creates pressure to more quickly provide service. In addition to these pressure, the number of prescriptions being dispensed is projected to increase 45% for 2000-2005 because of the increasing elderly population (National Association of Chain Drug Stores).

Similarly, one aspect of ‘service delivery’ is that services are variable. This means that as services are delivered by different people, the quality of the service fluctuates (Kotler, P., Marketing Management. Upper Saddle River, N.J.; 1997). With the amount of information produced today, healthcare practitioners cannot keep up-to-date in every category. Incorporating recommended guidelines into the point of care promotes standardization of the services provided by practitioners and does so to the highest standard. This is especially important in large organizations such as chain pharmacies. In order for them to deliver a service as a product, they must have a mechanism for all of their providers, spread out across the entire nation at times, to provide a standard, competent level of service. This is important to minimize the company's and practitioner's liability and to enable the company to market the service.

Presently, there is a substantial lack of use of such guidelines in the medical field. It is believed that a number of reasons exist for this. The guidelines are not mandatory and thus are discretionary. But further, it is difficult to keep up-to-date. This results in a number of patients not being treated to guidelines.

Attempts to have up-to-date guidelines to assist pharmacists (and physicians/prescribers) at the point of care is predominantly by making them available; e.g. web-based or by supplying hard copies of the same. This is cumbersome, time-consuming, and only as reliable as the practitioner's ability to keep up. Some computerized guidelines exist, but they are informational only. A practitioner can “look up” a guideline, but then must interpret and integrate it into his/her actions.

In the medical fields, documentation of activity is many times required. But this has not been as much the case with pharmacists. For example, it simply is not routinely done for specific services, such as patient interventions, e.g. diabetes. Presently most documentation relates to general matters such as the dispensing of prescriptions, inventory, accounting, and similar business-related aspects. Some exceptions exist.

One conventional mechanism specific to patient care for a company to document is to have the practitioner collect information on standardized paper forms and then have that data collected manually or to perform site audits. But, as prescription volume has increased over the last decade (and is projected to increase significantly over the next 15 years) with the aging population and managed care has minimized reimbursement driving up the time pressures, the amount of time available for intervention and documentation, even if done or contemplated, has been decreased.

Some attempts have been made to perform some aspects of data collection on desktop or laptop computers, but a substantial amount continues to be via paper forms.

While differences certainly exist relative to the specific problems, concerns, and issues faced daily by pharmacy students, instructors, private independent practitioners, private practitioners in large chain stores, and institutional practitioners, the paradigm shift created by increased patient intervention has produced needs that have commonalties and which beg for more global assistance.

Some attempts at improvement have been made. For example, in the pharmacist world, to assist in data gathering or documentation, students, teachers, and practitioners have begun to adopt computerized entry or storage of information. There have also been attempts to provide information such as guidelines for medicines in a more accessible form (e.g. on-line). These attempts may allow some advantages, similar to other uses of computers. One system can be used with hand-held computers. Conventional computing tools, e.g. calculator, can be included on the hand-held computer.

However, these attempts tend to be piece-meal and only partially effective in addressing the more global challenges. They tend to be informational. They do not provide pharmacist-focused assistance tools that can be an active part in intervention. They do not address many of the issues discussed above. For this type of informational system to be effective, the user has to know the right questions to ask. And, again, the user would have to memorize and keep up-to-date with every disease guideline developed and approved.

Other medical or healthcare fields have attempted to improve record keeping and documentation. Many electronic or computerized systems are in the marketplace. This includes movement towards hand-held devices that allow data entry and retrieval. However, again, most are piece-meal in approach, and are focused on providing information. A few allow data entry. Also, these systems tend to be focused on physician or nurse care. Room for improvement, though, still exists.

Some of the above-mentioned problems are therefore pervasive across most fields of healthcare. But, as indicated previously, the pharmaceutical field has its own unique issues and needs. There is a need for improvement in handling of data entry, management, manipulation and storage of information in the context of patient intervention and a pharmacist's practice. But further, there is need for improvements in educating pharmacist students. For example, better ways are needed to assist educators to not only have better access to students' documentation, but also to evaluate it, including an evaluation of the cognitive level of intervention a student reaches on a case by case basis. There is also a need to provide better tools to students when working on a case. This might include access to up-to-date information about a drug or a disease.

But further, there is a need to put such information into practice, for example, at the point of care being provided a patient. A further need exists to assist in building a record of the intervention for use, e.g., for documentation and/or evaluation purposes.

Similar needs exist for practicing pharmacists, including better ways to document actions, better ways for self or internal evaluation, and better tools to assist in the accuracy and efficiency and effectiveness of patient intervention.

### BRIEF SUMMARY OF THE INVENTION

A. Objects, Features, Advantages, and/or Aspects of the Invention

Therefore, there are real and significant problems and deficiencies in the art, and thus, real and significant needs for improvement in the art. It is therefore a primary object, feature, and/or advantage of the present invention to provide an apparatus and method for patient intervention assistance and evaluation which improves over and/or solves problems and deficiencies in the art.

Other objects, features, and/or advantages of the present invention include an apparatus and method as described above which:

a. is more global and flexible in its approach;

b. addresses the specific problems and issues involved in patient intervention;

c. facilitates improved patient intervention;

d. improves documentation, such as improved documentation management and reporting;

e. allows better record-taking and storage;

f. is integrated in approach;

g. helps consistency, objectivity, and uniformity;

h. helps learning;

i. helps teaching, assessment, and evaluation, including giving colleges a mechanism to quantify learning to provide a way to assess curriculum;

j. expands or improves usage of resources that can be used in teaching;

k. promotes a better learning experience;

l. is efficient and economical;

m. promotes more uniform quality of care;

n. allows improved self-help, self-evaluation, and provides backstop resources for practitioners;

o. deters errors;

p. is adaptable to various classes of users or environments of users;

q. allows integration of concerns/issues;

r. is scalable for individuals, large groups, and/or both; and

s. improves response to therapy, and promotes prevention/resolution of problems for patient.

One aspect of this invention is that it allows for the dissemination of treatment guidelines into the point of the intervention when practitioners are identifying and resolving patient treatment or therapy problems. Through the dissemination of guidelines into the point of care, practitioners can operate with the latest guidelines and improve patient care.

These and other objects, features, or advantages of the invention will become more apparent with reference to the accompanying drawings and claims.

B. Summary of Invention

The present invention relates to an apparatus, method, and system that provides a personal computer module that can be used by a healthcare practitioner or student, to more effectively practice and/or learn. The module is preferably portable with both input and output features. It can be communicated to another device. It includes software which integrates several practice functions. It can allow data transfer, both to another device for further use or to the portable module for point of care use.

In one aspect of the invention, the system establishes a mechanism to assess the level of cognitive complexity of patient interventions, an example being drug therapy interventions performed by students and pharmacists in pharmacy practice. In one embodiment, the assessment of drug therapy interventions is done through the pre-assignment of values to optional actions that can be taken by the practitioner, the values being weighted for increasing cognitive complexity. A total score, based on the values, can be calculated automatically. The score can be used to evaluate the performance of the practitioner or student, or used in other ways to promote education or the practice.

In another aspect of the invention, the system enables data entry and the capture of patient intervention information and automatically builds documentation related to the intervention. In another aspect of the invention, the system enables treatment or other types of recommended guidelines for the field of practice to be incorporated into the point of care. For example, in one embodiment, as healthcare practitioner or student performs an intervention, “disease guideline documentation implementors” are enabled that provide and prompt the intervenor with treatment guidelines at the point of care and automatically builds the guidelines into the documentation.

Another aspect of the invention enables the synchronizing of that data from the user's computer, such as a personal digital assistant (PDA) or hand-held computer, to an individual local computer or to a central location. One method to do so is via the worldwide web. In one embodiment, once the intervention is completed, the on-board data can be “synced” with another device, e.g. personal computer or local server, or sent to a central location, including via the Internet, or to multiple sites.

### BRIEF DESCRIPTION OF THE DRAWINGS

FIG. 1 is a schematic view of a system according to one embodiment of the invention, utilizing computers and intranets and/or extranets.

FIG. 2 is a schematic of a hand-held computer or personal information device that could be used with the embodiment of the invention of FIG. 1.

FIGS. 3.1 to 3.22, 3.23.1, 3.23.2, and 3.24 to 3.26 are exemplary screen shots for the hand-held computer of FIG. 2.

FIGS. 4.1 and 4.2 is a flowchart of an exemplary disease guideline documentation implementor useful in a system according to an embodiment of the invention.

FIGS. 5.1 and 5.2 is a flow chart of another example of a disease guideline documentation implementor.

FIG. 6 is a schematic of a scoring system for an intervention assessment tool that can be used with an embodiment of the present invention.

FIGS. 7.1, 7.2 and 7.3 are a form that can be used in conjunction with the scoring system of FIG. 6.

### DETAILED DESCRIPTION OF AN EXEMPLARY EMBODIMENT ACCORDING TO THE INVENTION

To achieve a better understanding of the invention, an exemplary embodiment will now be described in detail. Frequent reference will be taken to the drawings in this description. Reference numerals will be used to indicate certain parts or location in the drawings. The same reference numerals will indicate the same parts and locations throughout the drawings, unless otherwise indicated.

A. Overview

As can be appreciated by those of skill in the art, a practitioner's tasks and duties can vary significantly depending on a variety of factors and circumstances. They can change for the same patient. They can change for similar tasks. To illustrate the invention through a description of an embodiment of the invention, a general environment for such description will now be defined. It is to be understood, however, that the concepts discussed in this exemplary embodiment description have applicability in other analogous or related environments in the healthcare field.

B. General Environment of Preferred Embodiment

This exemplary embodiment will be discussed primarily in the context of a pharmacy student/pharmacy teacher environment, where the student is involved in patient intervention under the pupilage of the teacher. The pharmacy student will be referred to as “student” and the teacher as “preceptor”.

C. Apparatus/Hardware

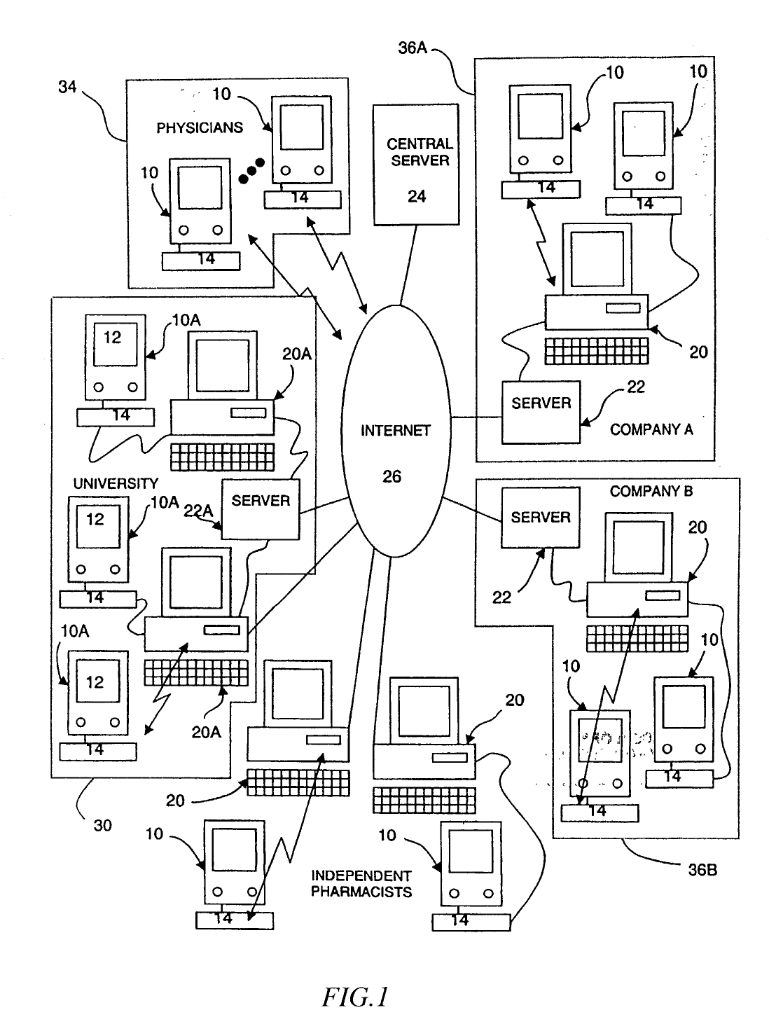

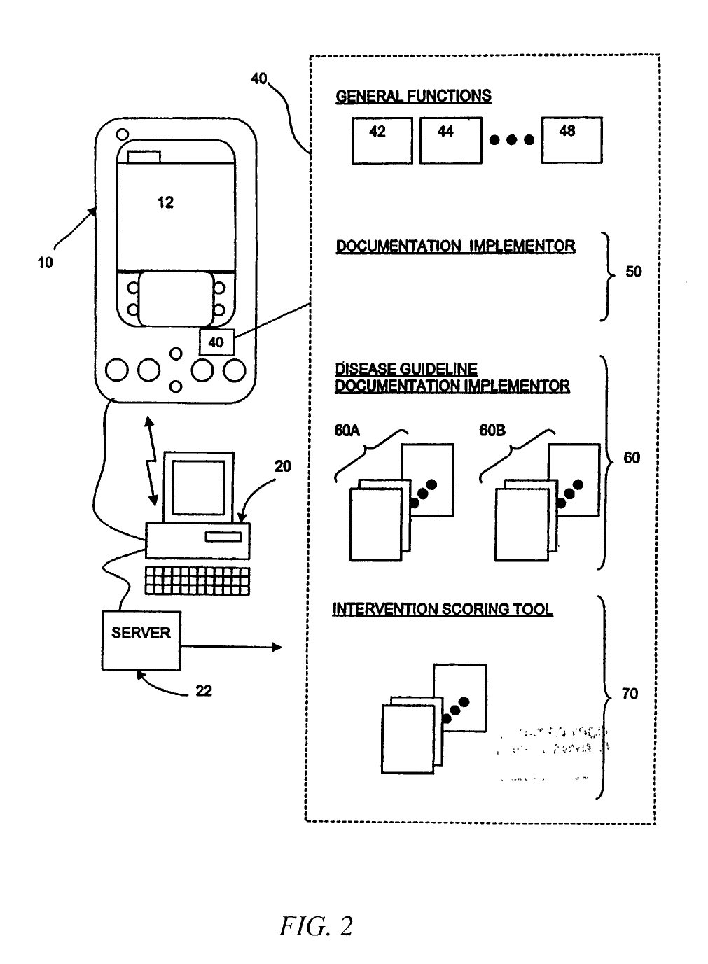

FIG. 1 illustrates diagrammatically a system that can be implemented through the use of hand-held PDAs 10. PDAs 10 are conventional, off-the-shelf devices. An example is a Palm Pilot i705 wireless available from Palm, Inc. of Santa Clara, Calif. or its commercial distributors. Other types of devices are possible including but not limited to small, personal computers, lap tops, or other similar devices that have a processor and an operating system. Preferably this would include a battery-powered PDA or other hand-held, hand-portable devices. It would also include multi-function devices such as cellular phones/wireless internet/PDA type devices.

A PDA allows a user to carry the device on-person and have it easily and portably available at all times. With normal on-board memory, PDA 10 has the ability to carry along substantial amounts of information and programming. As is conventional, PDA 10 includes a visual display 12 and a data input function (e.g. touch-screen type) so that the user can manually enter information. The student can carry it to class, to lab, to a patient, or to a pharmacy, as well as have it on-person virtually anywhere, including when studying or in consultation with preceptors.

PDA 10 is programmable. Software, discussed in more detail later, is pre-loaded and is updateable by well-known methods. The software particularly relevant to this exemplary embodiment will be generally referred to as software 40.

FIG. 1 illustrates that, optionally, PDA 10 can communicate with other devices. One example is via a conventional docketing station 14 allowing transfer of data to and from a PC 20. Data transfer can be wired or wireless, such as is known. Information in PC 20 can be transferred to PDA 10 or vise versa, such that both devices can be synchronized.

Further, as illustrated in FIG. 1, PDAs 10 and/or PCs 20 can communicate with still other devices. One example shown is with what will be called a local server 22. Local server 22 (e.g. a PC or mini computer) can provide a centralized location for receiving, storing, and/or processing data from a set of PDAs 10 and/or PCs 20. An example would be a local server 22A at a university 30 which is communicable with a plurality of PDAs 10A assigned to pharmacy students, directly or through PCs 20A. Through conventional authorizations (e.g. passwords), students can access software or other data from and send data to local server 22A (e.g. through their PCs 20A). Preceptors, such as university pharmacy professors or other preceptors, can access information from local server 22A, including documentation prepared by individual students in their case studies or assignments. The preceptors can evaluate and critique the students' work. Optionally, the students' data can be stored, organized and processed. This can allow for studies and academic work to be done on collective data. This can be called a type of intranet.

Still further, PDAs 10, PCs 20, and/or local servers 22 can be in communication with other devices. FIG. 1 depicts what will be called a central server 24. Devices 10, 20, and/or 22 can through wired and/or wireless connections communicate with central server 24 via a network such as a global world-wide network 26 (e.g. Internet), or other extranet. This could allow a university 30 to communicate with another university or universities, or with businesses or organizations. It can allow even further sharing and integration of information from a variety of sources, even if remotely located from one another.

As illustrated in FIG. 1, the system of the invention can be used with such other organizations. Examples depicted are independent pharmacists and/or their businesses 32, physicians or other health care providers 34, or commercial entities such as chain pharmacies or pharmacies in chain stores 36. Other examples exist. In each of these types of categories, anywhere from one to a substantial number of PDAs 10 can be used.

D. Software

PDA 10 is programmed for conventional functions such as data entry (pen-based, touch screen, etc.), and can have conventional applications such as a calculator, calendar, address book, task list, etc. It can also handle functions such as wireless paging or email, and other conventional functions.

For PDA 10, programming or software 40 was in CASLsoft scripting language (available commercially from CASLsoft Software of Philadelphia, Pa.) which is object oriented, event driven, and can be compiled into C language.

Programming of PDA 10 here will include functionalities specific to pharmacy student or pharmacist practice, such as will be described in more detail below.

FIG. 2 diagrammatically depicts one type of PDA 10 and an exemplary set of functionalities carried on-board or available to the user of the PDA 10.

General Functions. PDA programming could include several general functions that are useful to the students and preceptors. Examples are: calendar function 42, calculator function 44, email function 46, and synchronization of data 48. Others, of course, are possible.

Autodocumentation (50). As a part of data entry, PDA can allow a user to enter and store data. It can also present the user with pre-created templates that facilitate entry of documentation data in a pre-defined format into databases. The queries can be pre-designed to prompt the user on important information to gather.

Disease Guideline Documentation Implementors (60). A species of the autodocumentation, which the user can invoke at point of care with patients, will be called “disease guideline documentation implementors” 60. Discussed in more detail later, these documentation implementors essentially allow the user to call up a disease or condition (e.g. from a pull down menu) on display 12 of PDA 10 and have immediate access to up-to-date literature about the affliction, as well as be prompted during the intervention according to generally accepted or expert panel guidelines for treatment or utilization of drugs relative to the affliction.

Disease guideline documentation implementors 60 provide the student with expert assistance during patient intervention, thus acting as a virtual preceptor or resource on the spot to prompt them with the current guidelines.

Current guidelines can be designed into software 40 and consistently updated by periodic new releases of software 40. Further, the documentation of each intervention developed by the autodocumentation functions of software 40 can be synchronized between a PDA 10 and a PC 20, local server 22, and/or central server 24 so that both student and preceptor can look at the same documentation. As can be understood, specific disease guideline documentation implementors can be developed for as many different diseases as desired, as indicated by reference numbers 60A and 60B in FIG. 2.

Intervention Scoring (70). This function tracks the student's actions during patient interventions and can provide automated assessment of a student's actions. Preceptors can periodically check on the student by accessing the student's records. Preceptors can use the scoring to provide critique, remediation, or other assistance or grading of the student. This scoring can be shielded from students, can be seen but not known how it is calculated, or can be known or available to the students with understanding, depending on desire.

Additionally, this scoring can be used to compare students. It can be used to study the effectiveness of educational tasks or teaching. It can be used to create a knowledge-base for analysis on a more general scale.

The scoring in this embodiment is based on ideas discussed at Campagna, Keith D., “Pharmacists' Levels of Performance in Making Drug Therapy Decisions”, Am. J. Health-Syst. Pharm. 1995; 52:640-5, which is incorporated by reference herein. The software reviews the documentation of a student from a patient intervention and uses a scoring system designed to relate the student's actions to the Campagna levels of performance theory. The rating is associated with how far in the hierarchy of decision-making steps or performance levels the student went with the patient. The software then can identify the same, as well as allow a preceptor to evaluate the appropriateness of the student's actions for the particular patient and conditions. Furthermore, the scoring can identify such things as patterns, innovativeness, assertiveness, and other characteristics of the student that can be used in evaluating and teaching the student.

The scoring can also be used in a more integrated manner to develop intelligence about the effectiveness of certain drug therapy regimens or techniques by evaluating scores for a variety of students.

Other uses with similar advantages are possible for other groups, e.g. actual practitioners instead of students.

E. Operation

An exemplary operation of the system will now be described. First, a general discussion of the functionalities of a PDA 10 will be discussed. More detailed descriptions of certain aspects will follow thereafter.

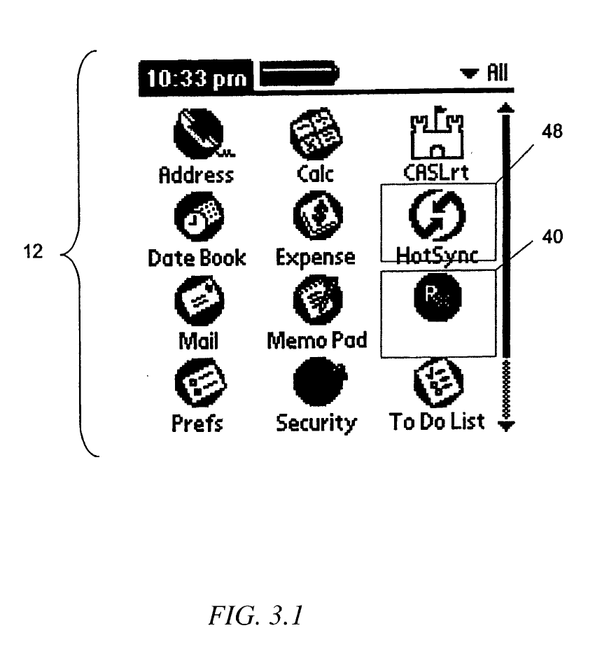

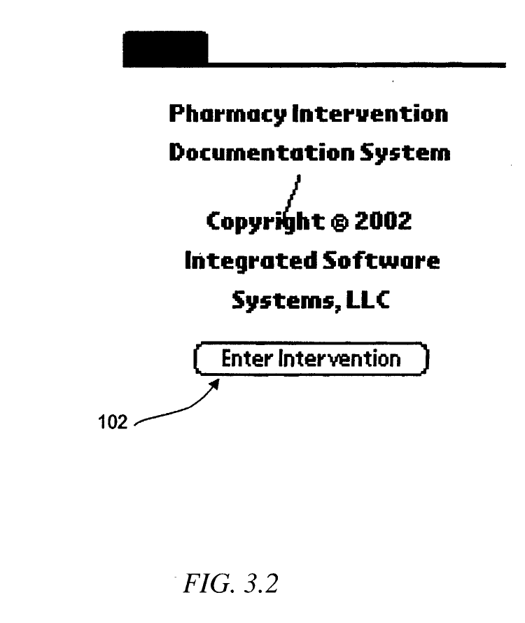

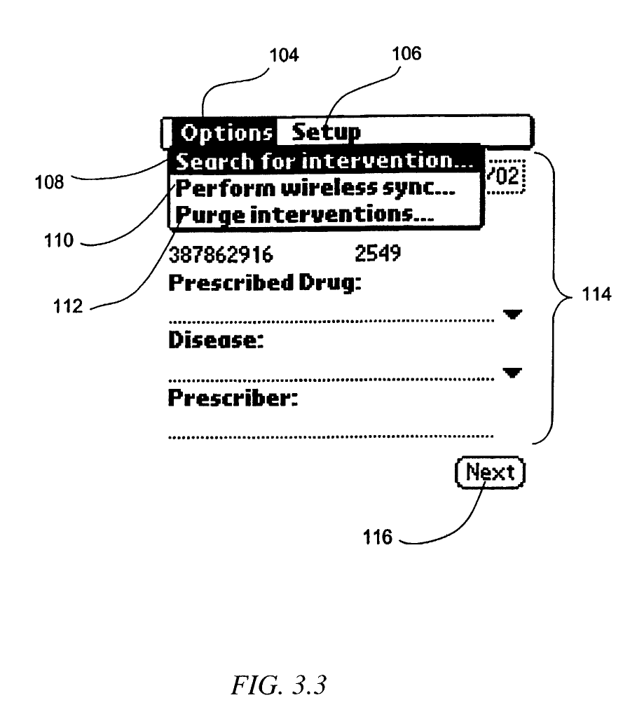

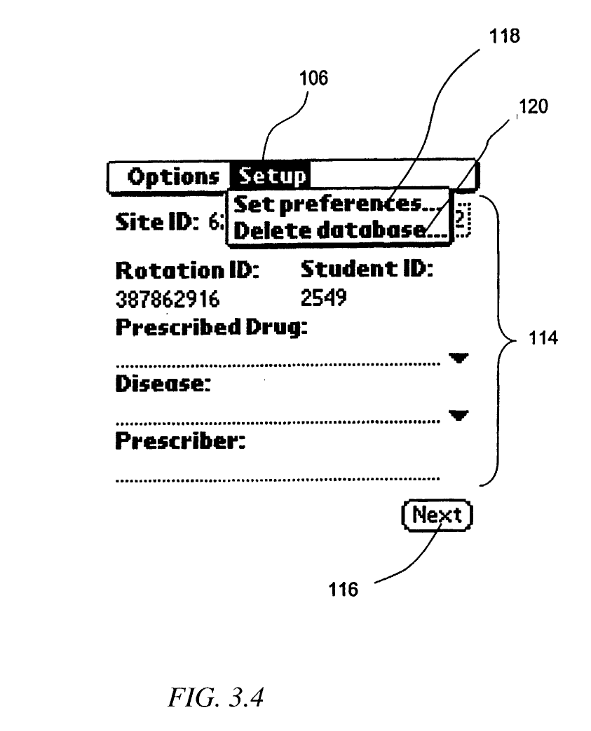

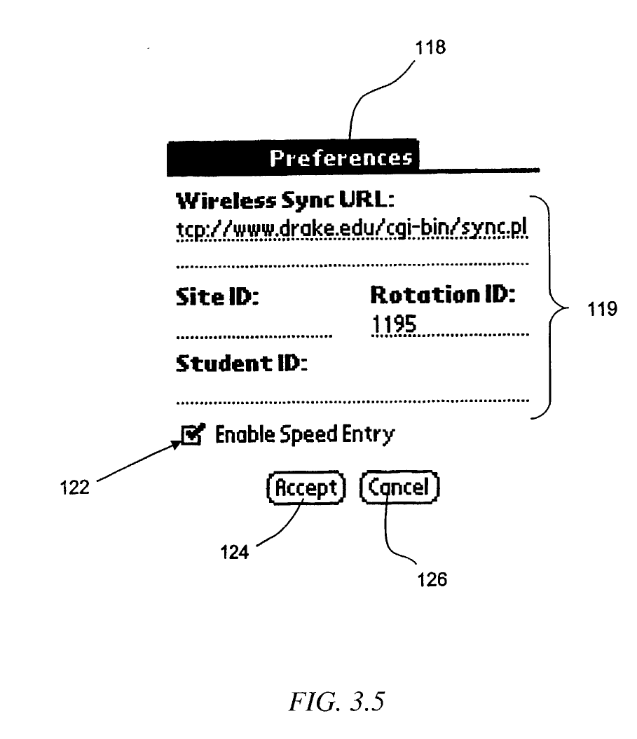

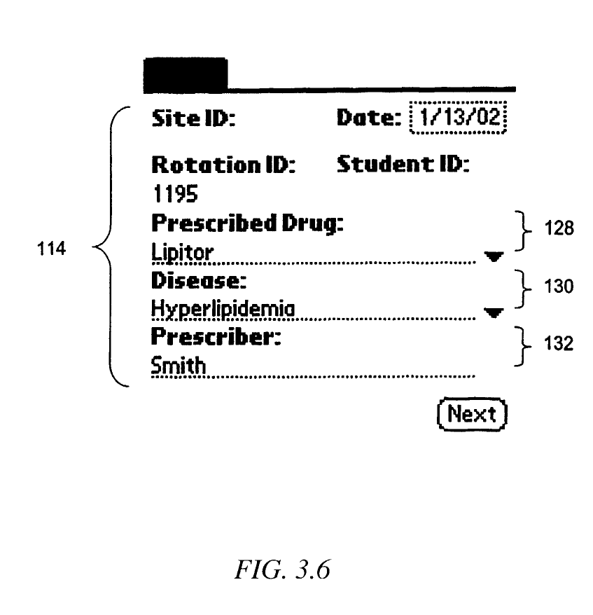

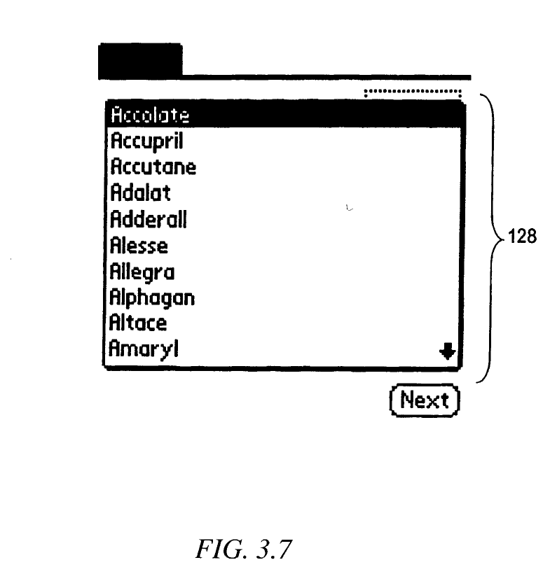

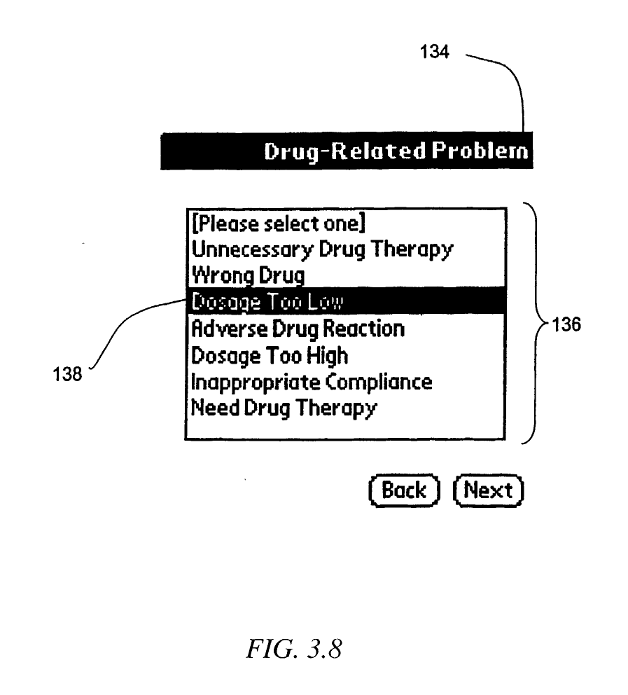

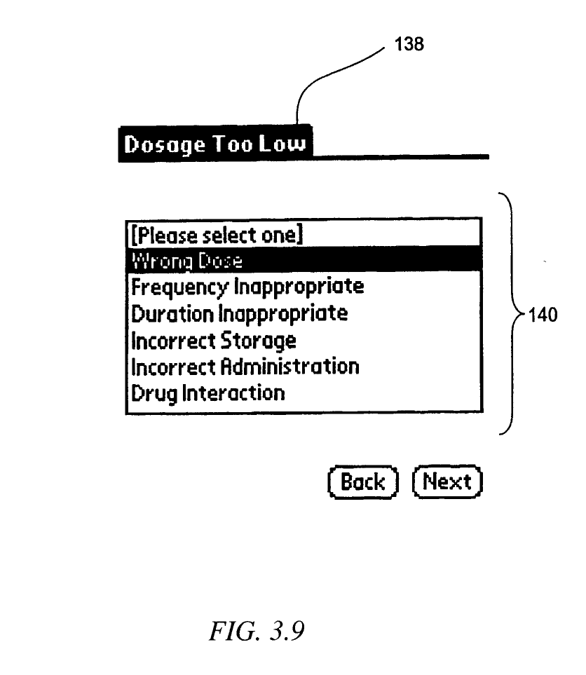

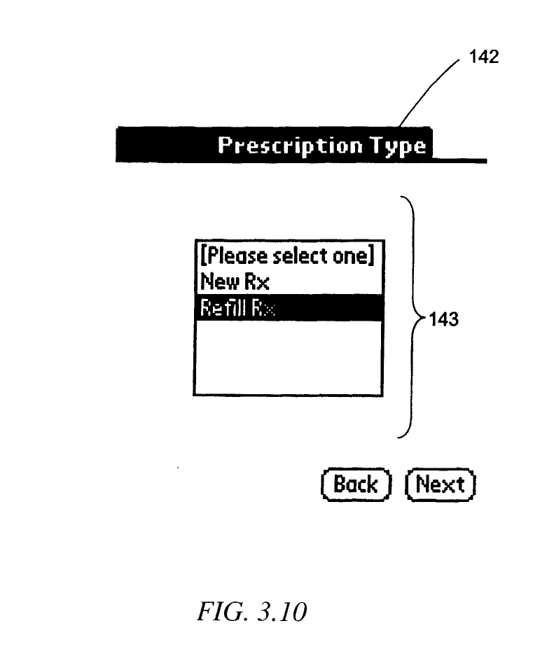

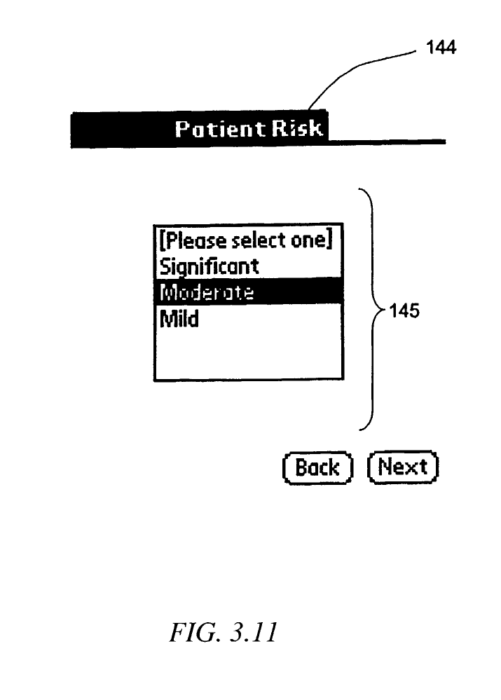

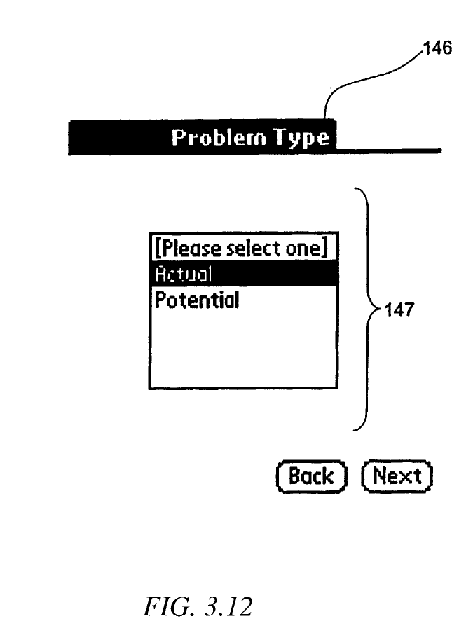

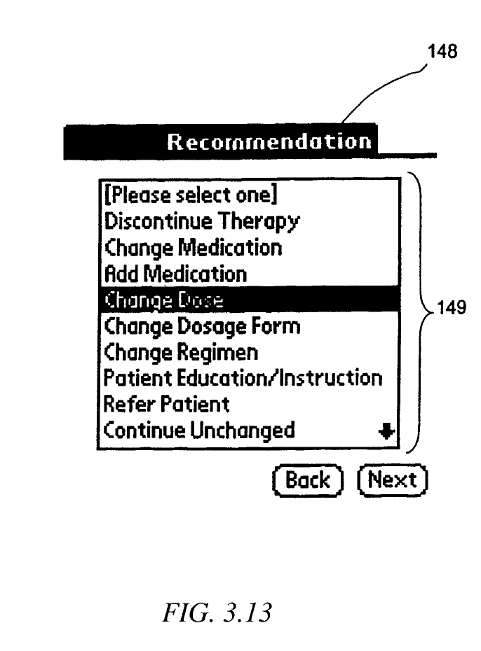

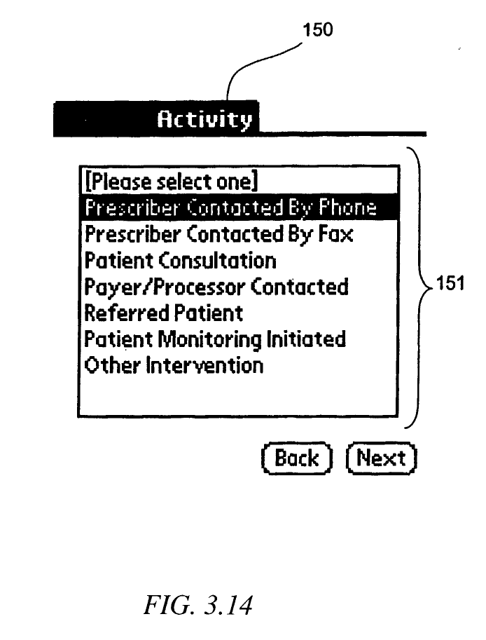

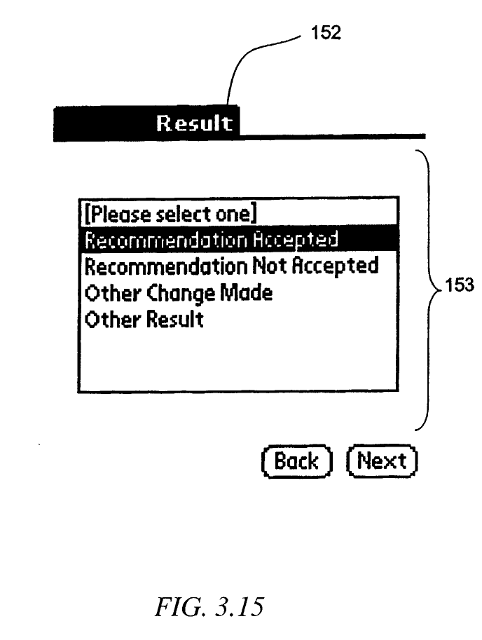

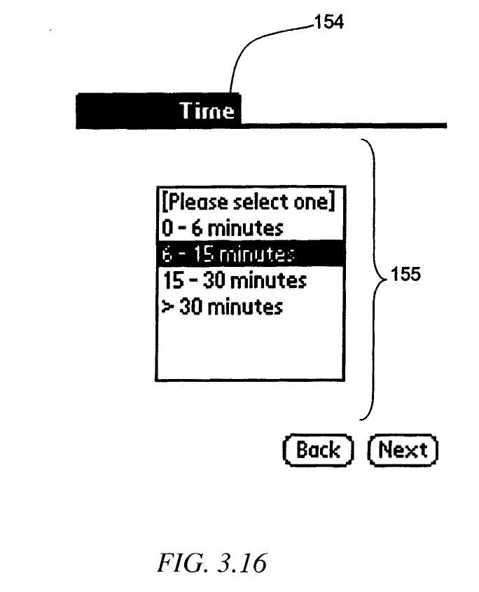

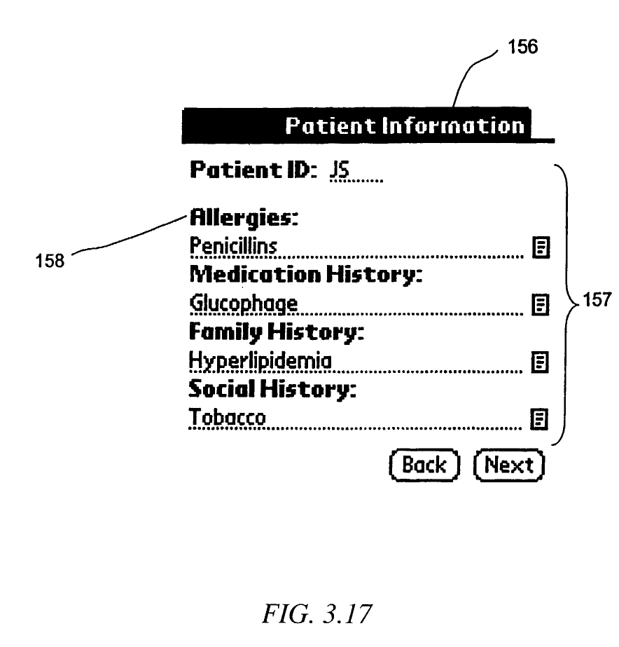

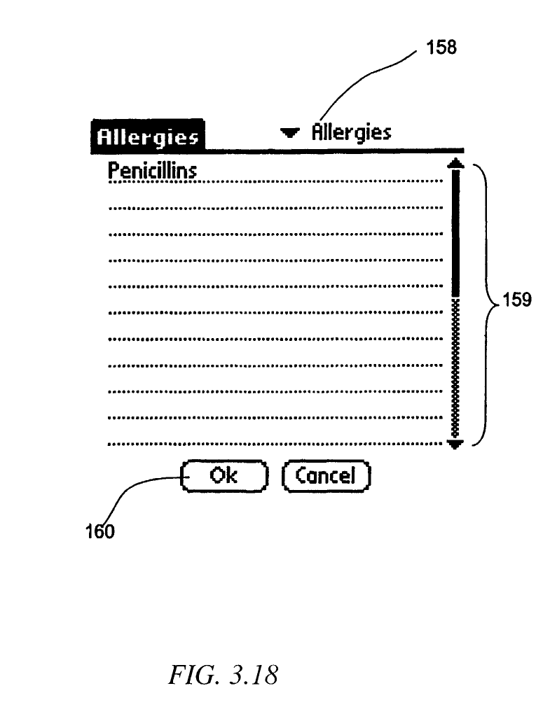

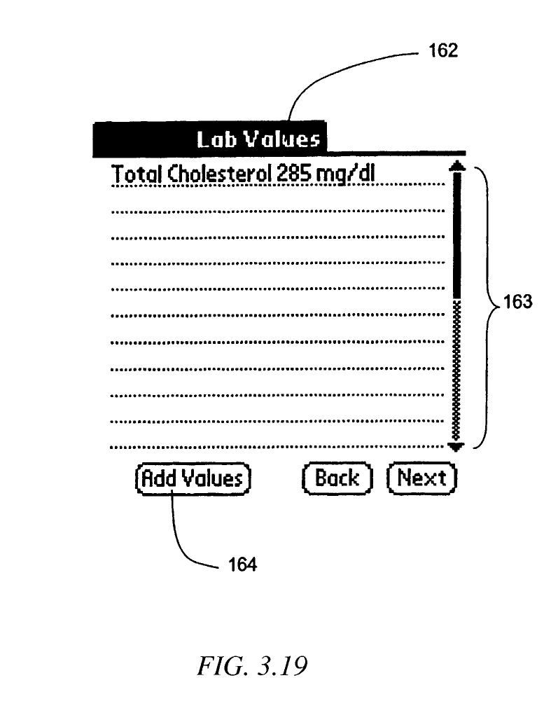

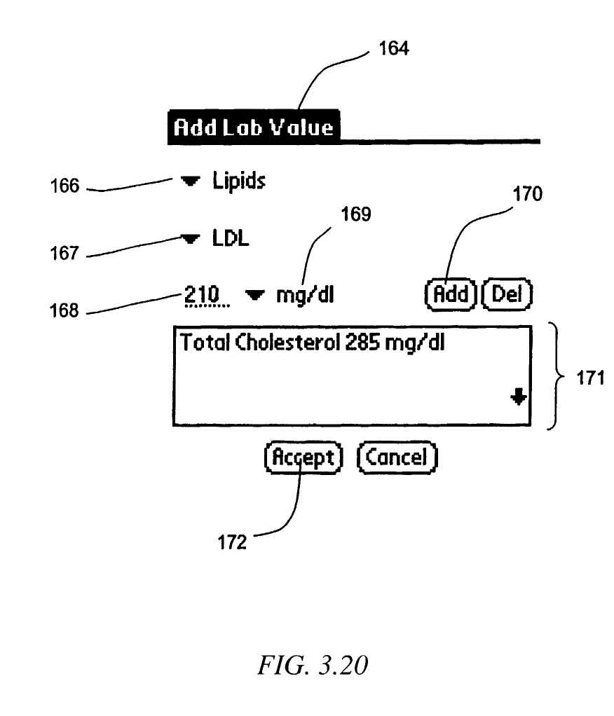

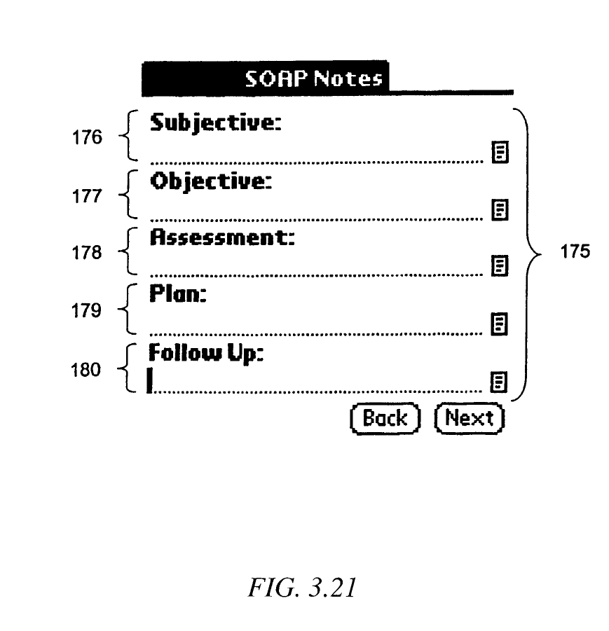

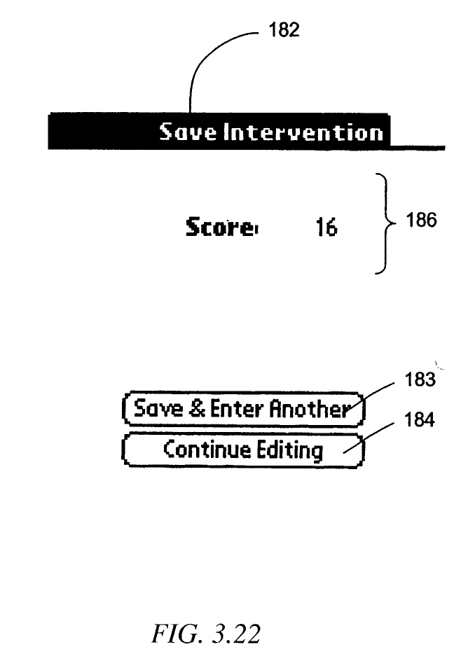

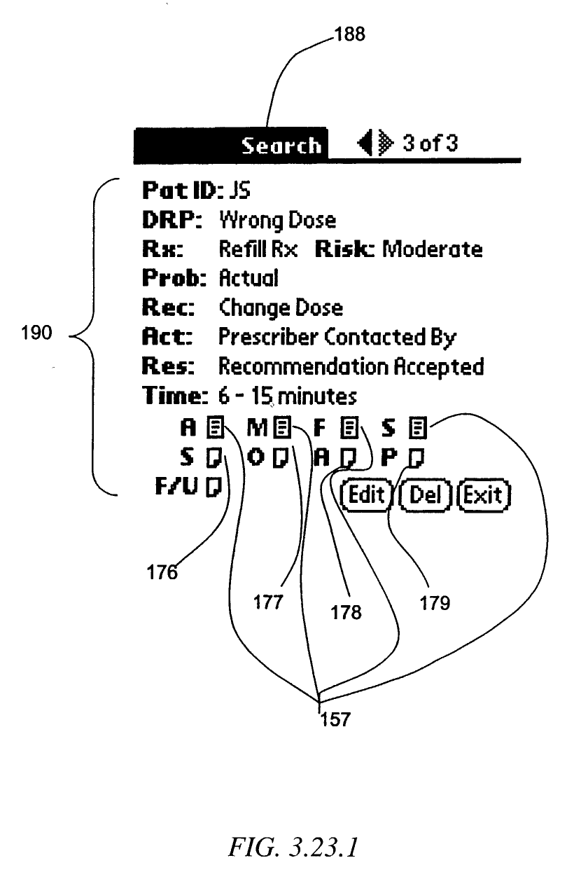

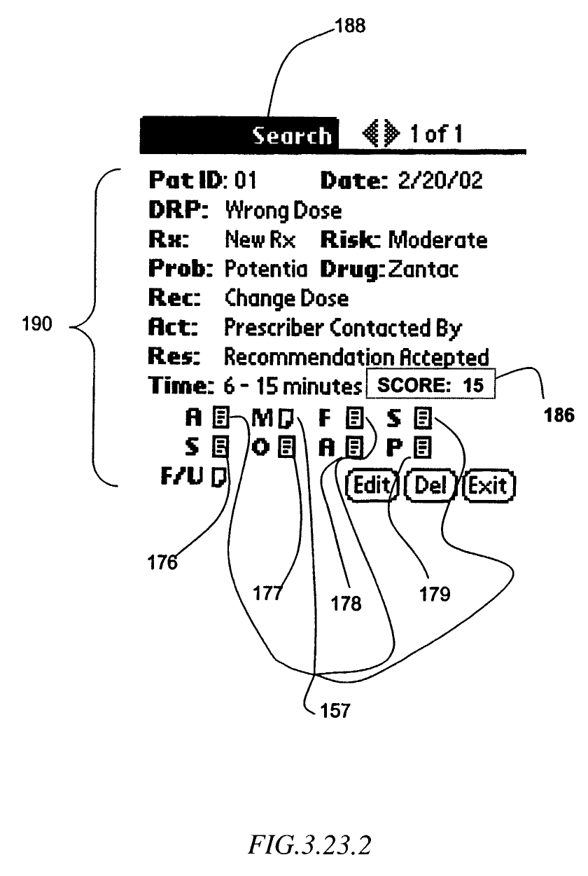

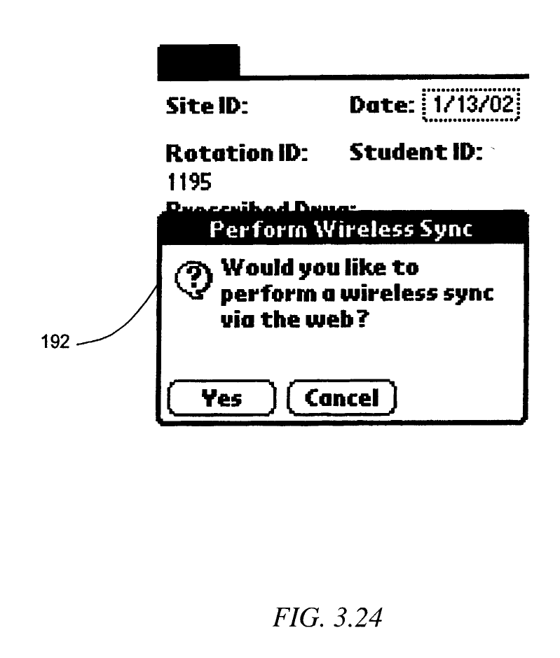

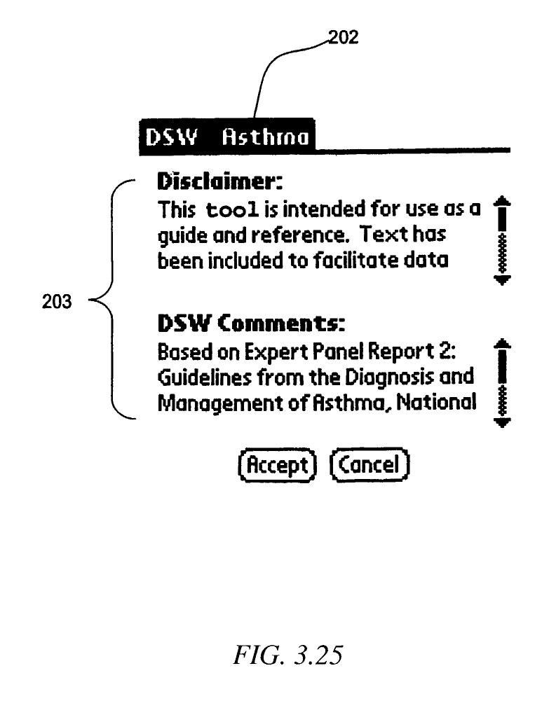

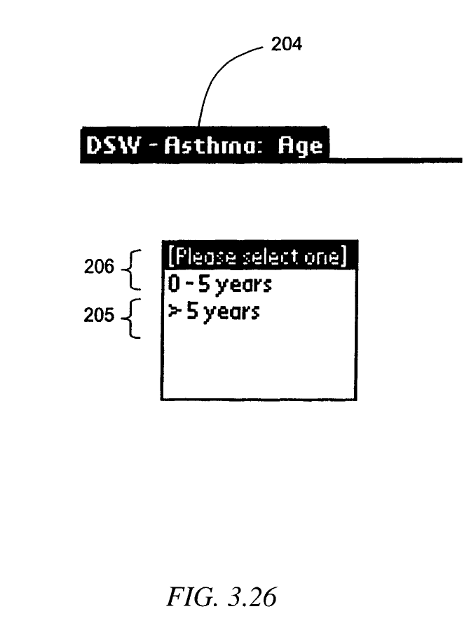

This description will refer most frequently to FIGS. 3.1 to 3.27. Each of these is an enlarged representation of a possible screen display for display 12 of PDA 10. The actual screen 12, including other icons or information that would typically be displayed on screen 12, as well as other parts of PDA 10 are not shown for simplicity. FIG. 2 illustrates diagrammatically the type of functionalities of software 40.

1. Set Up

FIG. 3.1. This screen shows an introductory or “home” screen for PDA 10. From this location, a variety of conventional applications are available by activating a corresponding icon. Examples are address book, calculator (44), date book or calendar (42), expense record-keeping, email (46), memo pad, to do list, “HotSync” for the synchronizing function (48); “security” for locking out access to others.

The icon for Software 40 also appears on PDA 10's screen 12 at “Rx”, which is an arbitrary indication of what will be called software or application or program 40, according to the present invention. The software 40 icon is the second from the bottom on the right-hand side of the screen. Touching this area (e.g. with PDA 10 pen) will activate software 40.

FIG. 3.2. This screen shows the initial screen of the software 40 application. The user touches the “Enter Intervention” button 102 on display 12 to begin. Thus, to begin use of the system, a student powers up PDA 10, and opens up application 40.

FIG. 3.3. This is the initial screen where data is first entered, and will be discussed in more detail below (see discussion of FIG. 3.6). Once application 40 is entered, the user is presented with two choices in the top-most function bar. One is “Options” (104). If chosen, a drop-down menu appears where the user can: (1) search for interventions (106); (2) perform syncing capabilities (108); or (3) perform purging functions (110).

Note how the initial screen in FIG. 3.3 has certain fields already filled in. The “search for interventions” option 108 allows the user to select a previously documented intervention stored on PDA 10, to continue work on the same or to review the same.

Option 110 allows PDA 10 to be placed in cradle 14 and/or synchronization of data between PDA 10 and PC 20 and/or server 22 and/or server 24 to occur. This process is well-known with respect to PDAs and will not be discussed in detail.

Option 112 allows prior documented interventions to be deleted or “purged” from PDA 10, if desired.

The “next” button 116 can be selected to move to another screen.

FIG. 3.4. This screen-shot shows the same screen as FIG. 3.3 but highlights the “Setup” (106) functions; namely the user can enter the preferences (118) screen or can also delete the database (120)—a function primarily used in the development stages.

FIG. 3.5. The “Preferences” (118) screen allows the user to pre-load certain information (119) that can automatically be called up by software 140 on each power-up of PDA 10. For example, this allows the user to pre-enter the website URL, or multiple URLs, the data is sent to upon syncing (function 110). It can sync to one or more sites. In this embodiment the user can sync to up to three sites. Preferences (118) also allow the user of the particular PDA 10 to pre-load such things as identification information (“IDs”), such as site, student, and rotation, so that such data does not have to be manually keyed in at every screen or start-up.

FIG. 3.5 also shows where various identification ID's are entered and shows the “enable speed entry” function (122). Function (122) moves the data entry screens forward without the user hitting the “next” button on each screen. The intent of this function is to reduce data entry time, but also to give the user the option of using it (see “accept” and “cancel” buttons (124) and (126)).

2. First Data Template

FIG. 3.6. This screen-shot shows initial data entry screen (FIG. 3.3) but without any pull down menus. Again, this is the first screen for entry of data (114) regarding a particular patient intervention. ID's are listed and the user can enter the date. Optionally, date can be automatically supplied. The ID's are pulled from the preference screen (118). Here additional data entered relates to the drug at issue for the patient (128), the disease being treated (130), and the prescriber of the drug (132). The down-arrows to the right of the “Prescribed Drug” and “Disease” fields (128) and (130) bring up drop-down lists of drugs and diseases to minimize and standardize data entry. As will be discussed in more detail later, when a disease is chosen that has what will be called a “disease guideline documentation implementor” programmed for it, the documentation implementor automatically pops up and gives the user the choice of using it. The user can also manually record the prescriber (132) at the screen of FIG. 3.6. If the documentation implementor is used, once completed, the user returns to this screen and continues. However, the documentation implementor may save time by having covered some or many of the subsequent queries in the program following this screen.

FIG. 3.7. This is an example of a drug list on the drop-down menu (128) of FIG. 3.6. A disease list (130) (not shown) would be similar; an alphabetized pre-loaded list of diseases or conditions to select from, which avoids the need for time-consuming manual keying and errors.

3. Assessment and Recommended Action Templates

FIG. 3.8. The next screen after the screen of FIG. 3.7 on the application 40 is the “Drug-Related Problem” or “DRP” field (134). Options (types of drug-related problems) are listed (136). A sub-list exists for each of these data points. Once the user chooses the appropriate DRP, the sub-list automatically becomes the next screen.

The highlighted DRP (138) in FIG. 3.8 is “Dosage Too Low”. This means the pharmacist has identified the patient's current dose of medication is insufficient to achieve the desired therapeutic result. The other DRPs are understandable to those skilled in the art. The DRPs are preselected to comprise a set of DRPs that are preferably at least fairly comprehensive of the possibilities for the particular field of endeavor.

FIG. 3.9. This is an example of the sub-list (140) for the “Dosage Too Low” (138) entry from FIG. 3.8. This allows the user to have a ready-made list of possible reasons a “dosage too low” designation might be selected for entry into the documentation. This again removes the burden of manual entry by the user of this information. Each DRP would have a sub-list like (140) but tailored to it.

Thus, the templates provide a pre-considered arrangement and content to assist the user in a patient intervention. The user does not have to operate on memory and has the backstop of the templates to use as checklist for relevant information to gather. But further, some of the templates provide sets of logical and carefully considered pre-loaded choices or options. This assists the user in being complete and comprehensive, as well as allows for accuracy and standardized consideration and communication of information gathered by the user.

FIG. 3.10. The next screen after FIG. 3.8 has the user identify the type of prescription (142), new or refill (143). If correction or review of previous screens is needed, the user can select the “back” button.

FIG. 3.11. The next screen has the user identify the patient risk (144) associated with this drug therapy problem, here giving three selectable options (145), “significant”, “moderate”, and “mild”.

FIG. 3.12. This next screen has the user identify the type of problem involved (146), and has two selectable choices, “actual” or “potential” (147).

FIG. 3.13. Software 40 then presents the next screen to the user with a prompt for the user to record the type of recommendation made (148). A variety of pre-loaded selections (149) are presented to the user. The list can quickly be scrolled through, and a selection made which is automatically entered into the documentation data being stored in PDA 10. Here the selection is “change dose”. The user can consider all the options and select from a set of choices related to the previous query, prompt or question. This automatic entry prompts the user and autodocuments action related to the recommendation. The software is programmed to record and store the user's selections to the prompts in selected locations relative to the documentation. For example, a recommendation is stored in the “plan” section of a SOAP note. This assignment can be based on common practice in the field. The software begins building documentation according to predetermined arrangement and content, as will be described further below for this embodiment.

FIG. 3.14. After the user enters a recommendation, and hits the “next” button (or the next screen automatically advances), this next screen allows the user to record the activity done (150) to perform the intervention. A pre-loaded list (151) is available to choose from. Here the example shown as selected is “Prescriber Contacted by Phone”. Once entered, this is automatically documented.

FIG. 3.15. This next screen allows the user to record the result (152) of the intervention from a pre-created list (153). Not only are the user's selections regarding the prompts and queries gathered and stored, but also the user's recommendation, actions taken to implement the recommendation, and whether the result is that the recommendation has been adapted. Again, the system presents a sequence of pre-designed queries and prompts to the user, presents pre-designed sets of choices and considerations to the user, and gives the user this assistance in real time, conveniently, including at the point of care of the patient. But further, the system in the background automatically builds documentation based on the data gathering and user choices. This saves time and resources, improves accuracy, and promotes standardization of care. It also provides documentation that can be easily accessible to authorized persons, such as preceptors, even at remote locations.

4. Subjective and Objective Data Gathering Templates

FIG. 3.16. This next screen is used to record the time (154) required by the user to perform the intervention. Software 40 thus allows for time-keeping records to be easily kept. As discussed above, time pressures are significant on the practitioner in the real world. This will help a preceptor and the student to evaluate efficiency. Conversely, it can indicate not enough time was spent. This screen shows time increments in tenths of hours (155). Other ranges, or minute by minute selections are possible. This can be a time-saving record for business or billing purposes, for example, for record keeping for payors (e.g. PPO's, HMO's, insurance companies) of the user's services.

FIG. 3.17. This next screen is used to record patient information (156) of the patient related to the intervention, including such data (157) as patient ID, allergies (158), medication history, family history, and social history. Each section, except patient ID, has drop-down boxes with typical information for each field and additional memo field space for the user to manually enter additional information. Other types of information are possible. This information can then be automatically sent to the “Subjective” field of the SOAP note, see FIG. 3.21.

FIG. 3.18. This is an example of the “Allergies” data entry screen (158) of FIG. 3.17. The user accesses the drop-down menu by tapping on the “Allergies” arrow and text at the top right of the screen. The user then chooses from the drop-down menu (159). If the user would like to add multiple allergies, the process is simply repeated and the text is entered on the next available line. When completed, the user hits the “OK” button (160) which takes the user back to the screen of FIG. 3.17.

FIG. 3.19. The next screen is the “Lab Values” (162) screen. Here, the user taps the “Add Values” button (164) at the bottom. When this is done, the next screen appears (FIG. 3.21).

FIG. 3.20. This screen shows how the “add values” function (164) of FIG. 3.19 is accomplished. After button (164) is pushed, the screen of FIG. 3.20 would appear on PDA 10. The first section (166) (where “lipids” appears on this screen) is a drop-down list of categories of various lab values. The user chooses the category, in this case, “lipids” (166) and then the second drop down arrow (167) (where “LDL” appears on this screen) appears with a drop-down list of lab values specific to that category. The user chooses the specific value to be added, in this case LDL, and then enters the value, in this case 210 (see reference number 168). Then the user chooses the units to be used (169). To add this lab value to the screen, the user taps the “Add” button (170) and the value is added to the box (171) below. The user repeats this process for as many values as desired and then taps the “Accept” button (172). When this is done, the values are added to the “Lab Values” screen (163) (FIG. 3.19) as seen above. These values are then automatically added to the “Objective” section of the SOAP note (see FIG. 3.21). Again, the system facilitates assistance for patient intervention by its predesigned prompts and queries, and its automatic building of pre-designed documentation. Other lab values or analogous information could be added, or the software could be designed for other or additional values.

5. Documentation

FIG. 3.21. As are well-known in the art, SOAP notes are a format of documentation that are helpful when practicing patient intervention. This “next” screen (174) shows the SOAP note field (175) that also includes “subjective” field (176) (taken from the answers to the queries of FIG. 3.17); “objective” field (177) (e.g. taken from the queries at FIGS. 3.18 to 3.20), “assessment” field (178) (e.g. taken from the queries at FIGS. 3.8 to 3.15), and “plan” field (179). A “Follow-up” field (180) or with additional or different queries or prompts, can be used. In the Follow-up field (180) of FIG. 3.21, a calendar will appear that adds a follow-up appointment to the user's calendar function 42 of the unit/PDA 10. As described, at this point the system can automatically build a SOAP note, in the background and transparently to the user, in this standard, well-known healthcare documentation format.

FIG. 3.22. The next screen is the screen (182) that allows the user to save the intervention (183) or continue editing (184). It also shows the score (186) for this intervention. This score has been automatically calculated as the user has chosen the different data entry points specific to the screens. A specific example is set forth later.

FIGS. 3.23.1 and 3.23.2. The screen at FIG. 3.23.1 (188) is a “Search” screen that allows the user to quickly access and scan the recorded interventions stored on PDA 10. This is even more complete automatically built documentation than FIG. 3.21, including not only the SOAP notes, but also displays on one screen a summary of selected answers to the previous pre-designed queries. This screen (188) is accessible from the options screen (104), see FIG. 3.3 at (108). As is illustrated on screen (188) in the data section (190), specific data about the intervention is made immediately available for viewing. More detailed data in the SOAP note (176, 177, 178, 179) is available by selecting the appropriate icon. Also, more detail is available about each of the allergy (“A”), medical history (“M”), family history (“F”), and social history (“S”) (collectively indicated by reference number 157) (see FIG. 3.17). Thus, this represents a built, autodocumented record of the patient intervention. Note also, that FIG. 3.23.1 is the most complete displayed record for a specific intervention. As indicated in the upper right hand corner of FIG. 3.23.1, in this example there are three records of interventions stored on this PDA 10, and screen (188) of FIG. 3.23.1 is a display of the third of those three records. Depending on memory size for PDA 10, many more such records could be stored on-board PDA 10. Another example of an autodocumented patient intervention is shown at FIG. 3.23.2. This record shows how a different intervention can be documented. In this example an intervention score 186 is included as a part of the documentation.

FIG. 3.24. This screen shows the pop-up screen (192) that appears when the user chooses to sync the interventions with the desired website/URL (see option 110 at FIG. 3.3). This allows a central storage of interventions from one or a plurality of PDAs 10. This can be used, for example, by the preceptor to evaluate, monitor and grade students.

6. Disease Guideline Documentation Implementors

FIG. 3.25. Software 40 includes routines or code sections called “disease guideline documentation implementors”. This screen (202) shows the beginning of the disease guideline documentation implementor for asthma. As previously described, this screen (202) appears as an option to the user when the user chooses “Asthma” in the disease field (130) on the first screen, FIG. 3.6. If the user chooses a disease guideline documentation implementor, the system takes the user through a sequence of screens, examples of which will be discussed below. By disease guideline documentation implementors, it is meant to convey the meaning that these tools are tailored to specific diseases. They are thus focused on assisting the user relative to a specific disease. They are thus a species of the more general automated documentation implementation of the system described earlier. But they do have differences from the more general documentation implementation, as will be discussed.

FIG. 3.26. Continuing from the example of FIG. 3.25, if the asthma disease state is selected, a second screen (204) of the asthma documentation implementor will be displayed and shows the first decision-point of this tool. In this example, the decision point (205) is a selection of the age range of the patient. This decision point, as are many or all of the decision points in this tool, is based upon guidelines related to the selected disease. These guidelines are well-known in the art.

Disease documentation implementors can be developed using national guidelines. These types of guidelines are essentially a knowledge base that are usually available to practitioners. They usually constitute recommended practices or generally accepted state of the art practices. The templates of the documentation implementor are specifically designed to incorporate the guidelines into the point of care. By this it is meant that the templates, and the queries, prompts, or choices presented to the user, are developed from the guidelines. This can include content, the questions posed to the user, the sequence of questions, and the scope of possible choices. In a sense, the guidelines are thus “built-in” to the tool, as opposed to simply being available for reference by the user. This facilitates the use of guidelines (in one sense forces their use), reduces error from the guidelines being remembered incorrectly or being incorrectly referenced, and/or reduces time by providing the reference at the point of care so the user does not have to look up the guidelines. It also reduces data entry as the answers and text are automatically added to the patient care SOAP note or other documentation.

Guidelines, some in digital down-loadable form, are available from such sources as www.guidelines.gov, and from the Center of Disease Control and the National Institute of Health.

These guidelines provide information to the pharmacist or student, or other healthcare practitioner or student, about a variety of topics, including certain diseases and recommendations or intelligence about the disease and drug therapy for the disease. The guidelines provide a valuable knowledge base for the practitioner.

They are figuratively “built-in” to the application 40 by designing the queries and templates around the guidelines. These guidelines are incorporated into templates stored on-board PDA 10. Presently, software 40 is periodically updated to follow updates of the guidelines. New releases of software 40 can then be up-to-date with the guidelines and periodically sent to users. Alternatively, new releases can be sent to PDA 10 (e.g. wireless download), or otherwise can be accessible to 10, 20 or 22 from, for example, a central server 24 or via the Internet, or revisions to software 40 may be made directly to PDAs 10, or devices 20 and 22, such as is becoming technologically available. This documentation implementor performs in the following manner.

The user identifies a disease of interest, e.g., from looking at or developing a diagnosis of a patient. The disease name can be selected from a pull down menu of diseases (see FIG. 3.25). An algorithm is programmed to take the user through a set of queries. (see e.g. FIGS. 3.26, and 4.1-.2). These queries are pre-created and follow the guidelines of the knowledge base specific to that disease.

The answers to the queries are recorded and automatically entered into SOAP notes for the user. Therefore, the documentation implementors make documentation quicker and easier, reduce variability, and reduce liability risks because the practitioner has the most up-to-date guidelines; and standardizes these services.

It allows the practitioner, and in some cases, forces the practitioner to have the most up-to-date guidelines immediately available.

As discussed elsewhere, the user or someone responsible for updating a PDA 10, can also periodically sync PDA 10 with one of desktop 20, local server 22, or central server 24 to keep identical records of interventions in both devices. See FIG. 3.24.

The documentation implementors allow quality control and standardized data collection which can be valuable for several reasons for practitioners or for the organizations with which the practitioner is involved or employed. It can assist the user in developing the SOAP notes of the types shown at FIGS. 3.23.1 and 3.23.2.

Below are examples of Asthma and Hyperlipidemia Documentation implementors. These are but two specific examples of these documentation implementors. Similar documentation implementors can be created for other diseases. As discussed below, it can be seen more clearly how guidelines can be integrated into queries that then automatically prompt a user when doing an intervention, and the answers to the queries are then automatically added to the documentation of the intervention. This includes providing ready-made text choices (from, e.g., a pull-down menu or displayed list).

### SPECIFIC EXAMPLE 1

### Asthma Disease Guideline Documentation Implementor.

As is illustrated in FIGS. 3.25, and 4.1 and .2, after selection of the “Asthma” documentation implementor (step 202) of FIGS. 3.25 and 4.1, the documentation implementor incorporates a disclaimer to the user (203), notifying the user that the documentation implementor is meant to be used as a guide and reference, and that text has been included to facilitate data entry and standardization of care. The user preferably can not edit the templates. However, the user should preferably be able to add free text or edit when the autodocumentation is dumped into a SOAP note, to edit or supplement what has been autodocumented.

This screen also identifies the guidelines used to create it, here being based on Expert Panel Report 2: Guidelines from the Diagnosis and Management of Asthma, National Institutes of Health: National Heart, Lung, and Blood Institute.

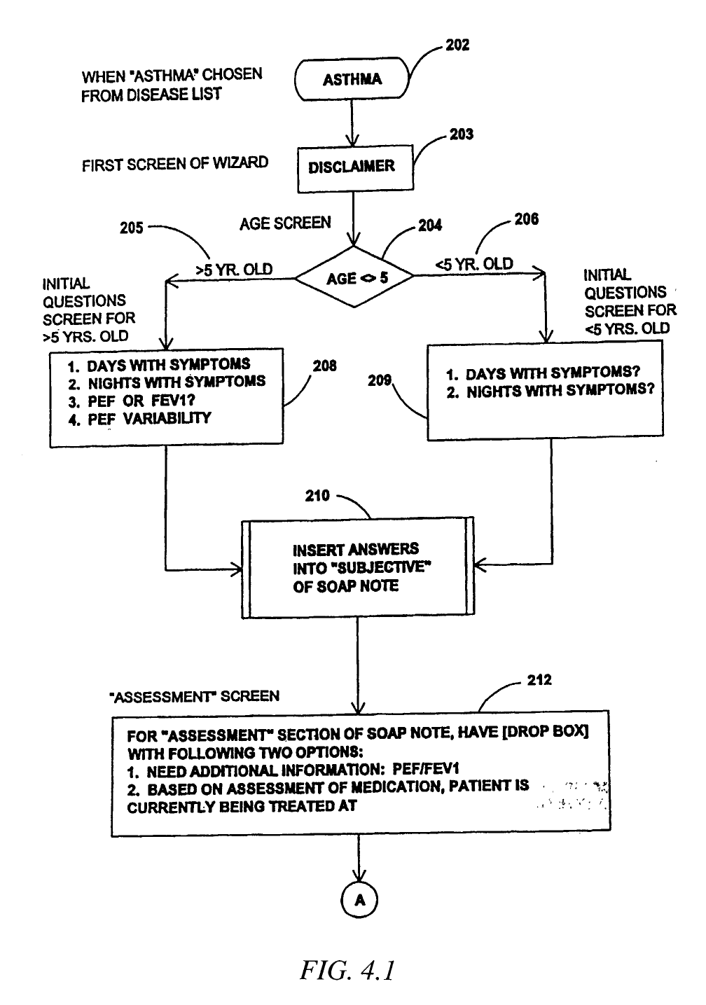

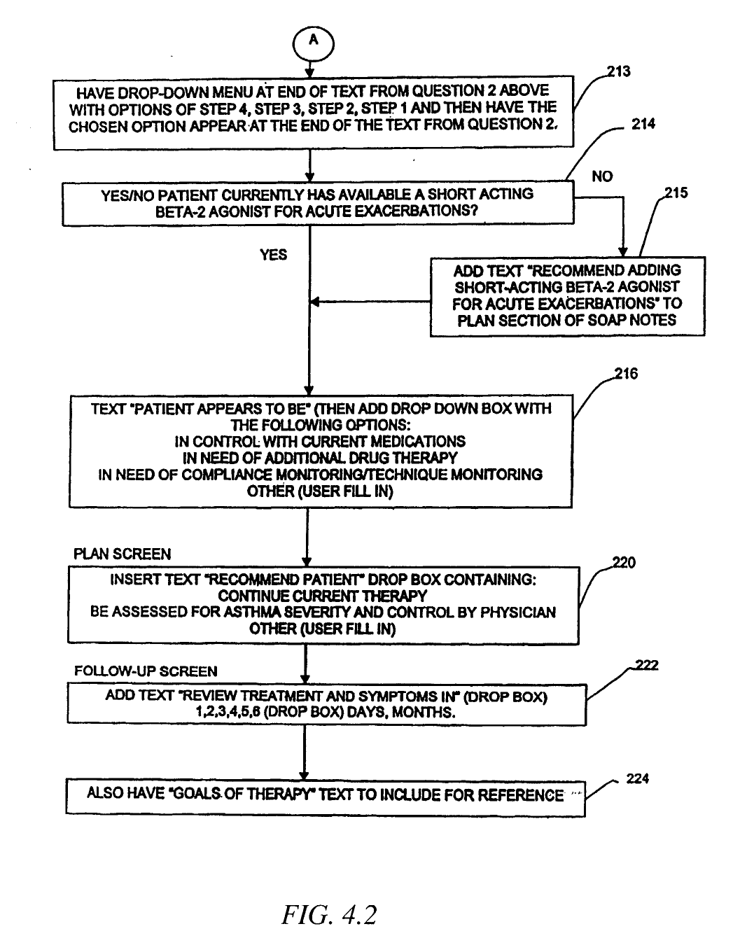

In this example the “Age” screen (204), FIGS. 3.26 and 4.1, guides the user to take the following action: If the patient is greater than 5 years old (205), use the guidelines shown at (208); if less than or equal to 5 years (206), use the guidelines shown at (209) where questions 3 and 4 of the Subjective part of Assessment are not included because it is not recommended to do PEF's or FEV's, asthma related tests such as are well-known in the art, on that age of patient. The user is given this intelligence, the two age ranges and whether PEFs and FEVs are to be used, by pre-designing the program to build this in as the first decision point as the user progresses. This built-in intelligence is from the knowledge base of the guidelines. The user enters answers to the initial questions of (208) or (209). The software 40 automatically enters the answers into the “subjective” portion of SOAP note (FIG. 3.21), see step (210) of FIG. 4.1.

The display 12 of PDA 10 automatically shows the user either (208) or (209), as determined by the answer to (204). Each of the questions numbered 1, 2, 3, and 4 at (208), or questions numbered 1 and 2 at (209), have drop down menus or lists, as set forth below. These questions, or queries, and the lists are based on the guidelines; thus, again, intelligence from the knowledge base or guidelines is built-into the displays presented the user. The text that would be displayed is indicated by quotation marks below. To the right of each optional selection for the drop-down lists is the classification given by the software depending on the user's answer to the question (one of Step 4, Step 3, Step 2, or step 1, which are based on the guidelines).

The subjective or “S” portion of the SOAP note, see (176) of FIG. 3.21, is generated as follows (assuming all four questions are displayed):

Question 1 from (208)
“1. Days With Symptoms?”

(drop box or check boxes)
“□ Continual” (if checked, classify as Step 4)
“□ Daily” (if checked, classify as Step 3)
“□ 3-6/week” (if checked, classify as Step 2)
“□ ≦2/week” (if checked, classify as Step 1)

Question 2 from (208)
“2. Nights With Symptoms?”

(drop box)
“□ Frequent” (if checked, classify as Step 4)
“□ ≧5/month” (if checked, classify as Step 3)
“□ 3-4/month” (if checked, classify as Step 2)
“□ ≦2/month” (if checked, classify as Step 1)

Question 3 from (208)
“3. PEF or FEV1”

(drop box)
“□ ≦60%” (if checked, classify as Step 4)
“□ >60%-<80%” (if checked, classify as Step 3)
“□ ≧80%” (if checked, classify as Step 2)

Question 4 from (208)
“4. PEF Variability”

(drop box)
“□ >30%” (if checked, classify as Step 3)
“□ 20-30%” (if checked, classify as Step 2)
“□ <20%” (if checked, classify as Step 1)

After these answers are entered by the user, the program automatically classifies the patient based on the highest classification level chosen for any of the questions (208). For example, if the user answers “Step 4” for question 1, “Step 3” for question 2, “Step 2” for question 3, and “Step 1” for question 1, the patient is classified in classification “Step 4” because it is the highest classification level. If the user answers “Step 3” for question 1, and “Step 1” for questions 2, 3, and 4, the patient would be classified in level “Step 3”. If the answers for all questions are “Step 1”, the patient is classified at level “Step 1”. This is according to the guidelines. Therefore, the user must just enter the answers and the software, with the built-in intelligence of the guidelines incorporated into the queries and prompts, classifies the patient within the guidelines. The software can then automatically add this classification to the documentation, if desired.

The objective or “O” portion of the SOAP note is generated according to the following rule. The user is prompted on the PDA screen to enter information. Here the information requested are the actual lab values from the PEF or FEV1 tests. It is to be understood that software 40 can prompt the user to enter these values (e.g. from a screen display) and can automatically build them into the documentation or SOAP note, but this is not shown in FIG. 4. 1.

The assessment or “A” portion of the SOAP note, see “assessment screen” (212) of FIG. 4.1, is generated according to the following method. The user is presented with the following two queries, with options in a drop box for each, on screen 12:

Question 1 of (212)
“1. Need additional information”

(drop box)
“□ PEF”
“□ FEV1”

Question 2 of (212)
“2. Based on assessment of medications, patient is currently being
treated at”

(drop box (213) is displayed with the following optional

selections)

“□ Step 4”
“□ Step 3”
“□ Step 2”
“□ Step 1”
“□ unknown”.

When the user makes one of the foregoing selections, the software automatically places the selection at the end of question 2 of (212), and then autodocuments the answers to questions 1 and 2 of (212). The program then moves to (214) and displays the following query:

Question of (214)
“Patient currently has available a short acting beta-2 agonist for
acute exacerbations?”

(drop box has two options)
“□ Yes”
“□ No”.

If the user selects “No”, the program automatically fills in the “Plan” section of the SOAP note to include the following text: “Recommend adding short acting beta-2 agonist for acute exacerbations.” If the user selected “Yes”, the program proceeds to the following display (216).

Question of (216)
“Patient appears to be”

(Drop box options)
“□ in control with current medications”
“□ in need of additional drug therapy”
“□ in need of compliance/technique monitoring”
“□ other _{—}_{—}_{—}_{—}_{—}_{—}_{—}_{—}_” (user fills in).

The user selects and/or completes the queries and prompts, which again, are based on the guidelines. Then, the answers are available to automatically build into the documentation, here the Assessment section of the SOAP note.

The plan or “P” portion of the SOAP note, see (220) of FIG. 4.1, is generated according to the following method. The following query is displayed:

“Recommend patient”

(drop box with following options)
“□ continue current therapy”
“□ be assessed for asthma severity and control by physician”
“□ other _{—}_{—}_{—}_{—}_{—}_{—}_{—}_{—}_” (user fill in).

The user completes this section, which is pre-designed based on the guidelines, then this is autodocumented by the system 10.

Next, a follow-up or “F/U” screen, see (222), is generated which presents the following query:

“Review treatment and symptoms in”

(drop box of options is presented)
“□ 1”
“□ 2”
“□ 3”
“□ 4”
“□ 5”
“□ 6”
(further drop box)
“□ days”
“□ months”.

This is autodocumented by the program.

A pop-up screen (224) called “Goals of Therapy and Treatment Options” (this could be two separate pop-ups), could then be generated on display 12. This includes text that is available to the user to help understand the guidelines better. An example of such text for asthma, based on the asthma guidelines, is as follows:

“Goals of Therapy

Minimal or no chronic symptoms day or night
Minimal or no episodes
PEF ≧ 80% of personal best, if used
Minimal use of inhaled or short-acting beta2-agonist (<1
per day)
No or minimal adverse effects from medications

Treatment Recommendations:
Step 4 = Severe Persistent:

Adults and Children More Than 5 Years Old

Inhaled Steroid - high dose
Long-acting inhaled beta2-agonist - adult 2 puffs (child 1-2
puffs) q12 hours, sustained-release theophylline, or oral
long-acting beta2 agonists plus
Steroid tablets or syrup long term; make repeated attempts
to reduce oral steroids.

Infants and Young Children 5 Years of Age and Younger

Inhaled Steroid - high dose
If needed, add systemic steroid - 2 mg/kg/day. Reduce to
lowest daily or alternate-day dose that stabilizes symptoms.

Step 3 = Moderate Persistent

Adults and Children More Than 5 Years Old

Inhaled steroid - medium dose
Or
Inhaled steroid - low-to-medium dose plus long-acting
inhaled beta2-agonist - adult 2 puffs (child 1-2 puffs) q12
hours, sustained-release theophylline, or oral long-acting
beta2 agonists.

If needed, increase medications up to: Inhaled
steroid - high dose plus long-acting beta2-agonist,
sustained-release theophylline, or oral long-acting
beta2-agonists.

Infants and Young Children 5 Years of Age and Younger

Inhaled steroid - medium dose
Once control is established 2-3 months, consider:
Inhaled steroid - lower medium dose and nedocromil OR
Inhaled steroid - lower medium dose and theophylline - 10
mg/kg/day up to 16 mg/kg/day for children ≧ 1 year of age.

Step 2 = Mild Persistent

Adults and Children More Than 5 Years Old

Inhaled steroid - low dose
Or
Cromolyn - adult 2-4 puffs (child 1-2 puffs) tid-qid, or 1
ampule by nebulizer tid-qid,
Or
Nedocromil - adult 2-4 puffs (child 1-2 puffs) bid-qid
Sustained -release theophylline to serum concentration 5-
15 mcg/ml is an alternative, but not preferred, therapy.
Zafirlukast or zileuton may also be considered for
patients ≧ 12 years of age, although their position in
therapy is not fully established.

Infants and Young Children 5 Years of Age and Younger

Cromolyn - 1 ampule tid-qid by nebulizer
OR
Nedocromil - 1-2 puffs bid-qid by MDI (usually begin with

one of above two drugs)

OR
Inhaled steroid - low dose

Step 1 = Mild Intermittent

Adults and Children More Than 5 Years Old

No daily medications

Infants and Young Children 5 Years of Age and Younger

No daily medications

Notes on Classifying Severity:

Patients should be assigned to the most severe step in
which any feature occurs.
Patients at any level of severity can have mild, moderate, or
severe exacerbations.
Patients with two or more asthma exacerbations per week
(i.e., progressively, worsening symptoms that may last
hours or days) tend to have moderate-to -severe persistent
asthma.

Starting Point
Gain control as quickly as possible. Either start with aggressive
therapy (e.g. add a course of oral steroids or a higher dose of
inhaled steroids to the therapy that corresponds to the patient's
initial step of severity”’or start at the step that corresponds to the
patient's initial severity and step up treatment if necessary.
Step Down
Review treatment every 1 to 6 months. If control is sustained for
at least 3 months, a gradual stepwise reduction in treatment may be
possible.
Step Up
If control is not maintained, consider step up. Inadequate control
is indicated by increased use of short-acting beta2-agonists and in
step 1 when patient uses a short-acting beta2-agonist more than
two times a week; steps 2 and 3 when patient uses short-acting
beta2-agonist on a daily basis OR more than three to four times in
1 day. But before stepping up: Review patient inhaler technique,
compliance, and environmental control (avoidance of allergens or
other precipitant factors). A course of oral steroids may be needed
at any time and at any step.
Exercised-Induced Bronchospasm
Patients with exercise-induced bronchospasm should take two to
four puffs of an inhaled beta2-agonist 5 to 60 minutes before
exercise.
Referral
Referral to an asthma specialist for consultation or co-management
is recommended if there is difficulty maintaining control or if the
patient requires step 4 care. Referral may be considered for step 3
care.
Patient Education/Environmental Control - Help patients identify
and control precipitants of asthma episodes. Provide education on
self-management.
Use spacer/holding chamber for inhalers and mouth rinsing after
steroid inhalers.”

It can be seen how the above-described documentation implementor assists a user by walking the user through the needed questions and answers. It is predesigned from the guidelines so that the guidelines are essentially built-in and present as the user is practicing the patient intervention; in other words, the guidelines are incorporated into the point of care. And, the building in of the guidelines follows the user's actions by becoming built-in to documentation of the intervention which the software is automatically building in the background as the user progresses through the routine.

### SPECIFIC EXAMPLE 2

### Hyperlipidemia Disease Guideline Documentation Implementor

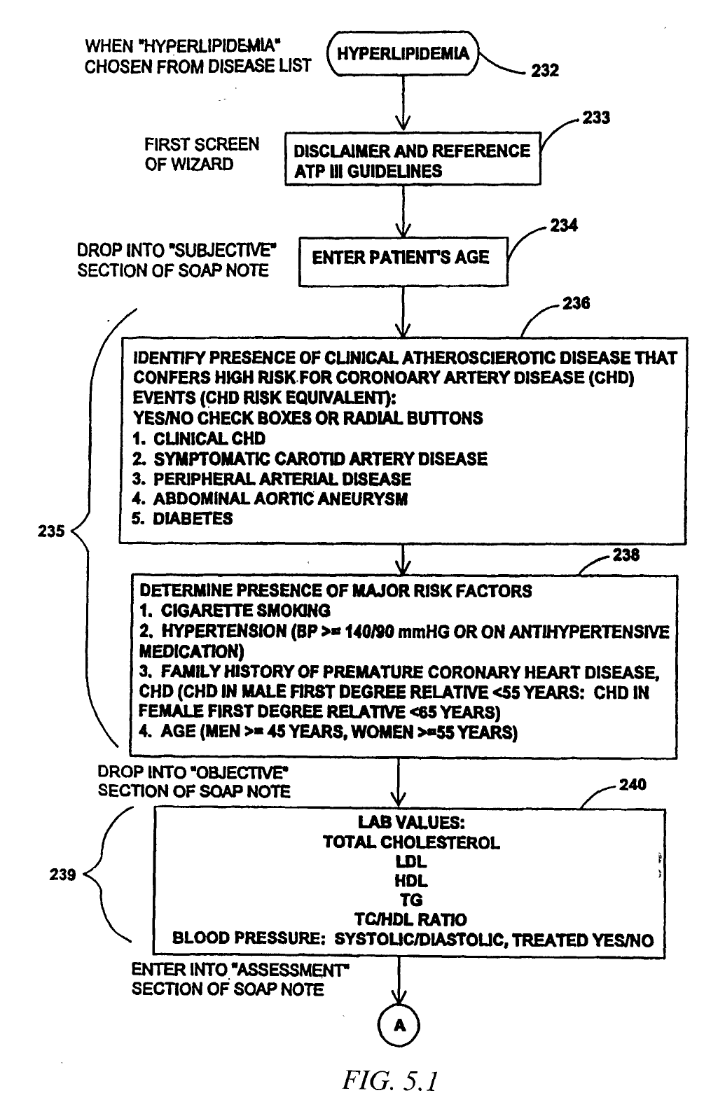

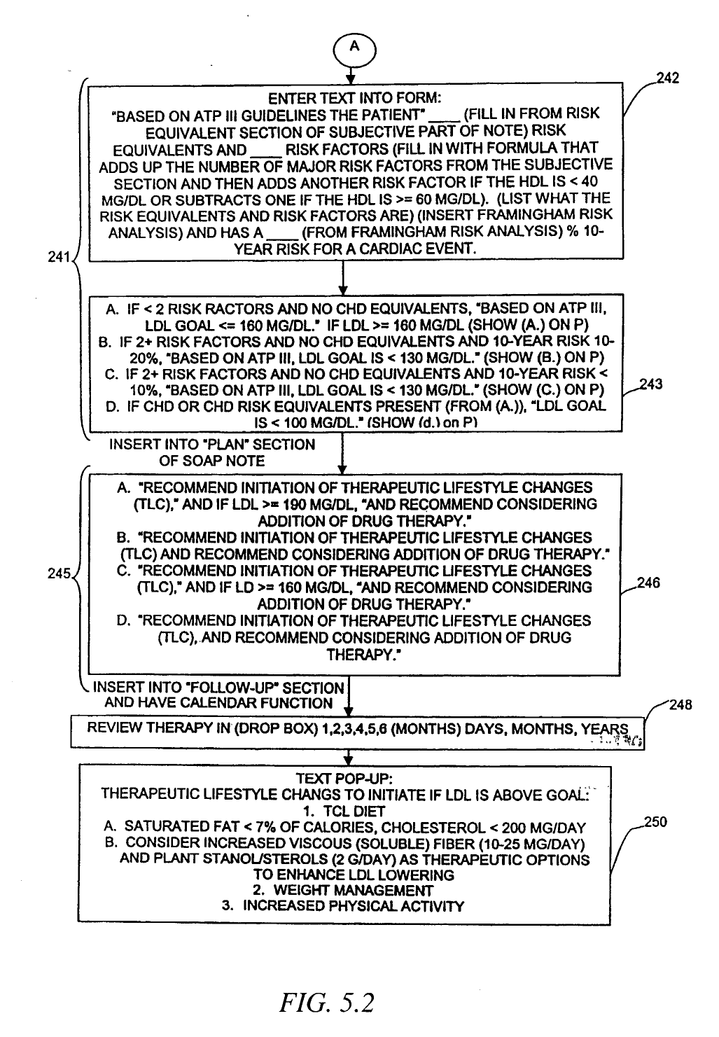

This second example operates in a similar fashion to the first example regarding asthma. Reference should be taken to the flow chart of FIGS. 5.1 and .2.

If “hyperlipidemia” is selected as the disease at (130) of FIG. 3.6, a disease documentation implementor (230), following the algorithm of FIGS. 5.1 and .2, would become active. The user could select it and a first screen (not shown) similar to FIG. 3.25 would appear, and include a disclaimer, such as: “Disclaimer: This documentation implementor is meant to be used as a guide and reference. Text has been included to facilitate data entry and standardization of care. The user should add free text to supplement what has been provided.”

Here the guidelines could be based on the ATP III Guidelines of the National Cholesterol Education Program. Each of the SOAP notes could-be generated by the user answering the following queries and prompts:

S (235):

Query (234).
“AGE: _{—}_{—}_years old” (enter a value).
Query (236).
“Identify presence of clinical atherosclerotic disease that confers
high risk for coronary artery disease (CHD) events (CHD risk
equivalent)”:
(Yes/No Check Boxes or radial buttons)

“□ Clinical CHD”
“□ Symptomatic carotid artery disease”
“□ Peripheral arterial disease”
“□ Abdominal aortic aneurysm”
“□ Diabetes”

Query (238).
“Determine presence of major risk factors:”
(Yes/No Check Boxes or radial buttons)

```
“□ Cigarette Smoking”
“□ Hypertension” (BP ≧ 140/90 mmHg or on antihypertensive
  medication)
“□ Family History of Premature coronary heart disease, CHD”
  (CHD in male first degree relative < 55 years: CHD in
  female first degree relative < 65 years).
“□ Age” (men ≧ 45 years; women ≧ 55 years)
```

The relevant guidelines are used to predesign these queries and once answered the “subjective” part of a SOAP note is autodocumented.

O (239):

Query (238)
“Enter the following values or answers:

| | |
|---|---|
| Total Cholesterol (TC) | _{—}_{—}_{—}_ |
| LDL | _{—}_{—}_{—}_ |
| HDL | _{—}_{—}_{—}_ |
| TG | _{—}_{—}_{—}_ |
| TC/HDL ratio | _{—}_{—}_{—}_ |

Blood Pressure: Systolic_{—}_{—}_mmHg Diastolic_{—}_{—}_
mmHg”
“Treated?”
“□ Yes”
“□ No”.

A (241):

Query (242).
“Based on ATP III guidelines the patient has_{—}_{—}_” (Fill in from risk
equivalent section of Subjective part of note) “risk equivalents and
_{—}_{—}_risk factors” ((Fill in with formula that adds up the number of
major risk factors from the subjective section and then adds
another risk factor if the HDL is < 40 mg/dl or subtracts one if the
HDL is ≧ 60 mg/dl) (If possible, list what the risk equivalents and
risk factors are)) “and has a_{—}_{—}_” (from Framingham Risk analysis)
“% 10-year risk for a cardiac event.”

The Framingham Risk Analysis is a well-known study, see, Castelli, W. P., Garrison, R. J., Wilson, P. W. F., Abbot, R. D., Kalousdian, S., Kannel, W. B., Incidence of Coronary Heart Disease and Lipoprotein Cholesterol Levels: The Framingham Study. JAMA. 1986; 256:2835-8. It can be seen how the guidelines are integrated into the queries on templates presented to the user. For example, the screen 12 of PDA 10 would present not only what the user should ask, and what information to gather, but also presents the rules or standards or model (e.g. Framingham Risk analysis) from the knowledge-base that are the guidelines. The user does not have to remember them, interpret them, or otherwise locate and apply them. They are built-in to the template. The queries of the template take the practitioner through the recommended, up-to-date steps for specific services or diseases. After the foregoing queries have been answered, the user would select from the following choices that would be displayed to the user(in double quotation marks), and the corresponding text of the selected choice (in single quotation marks) would be automatically documented into the “plan” or “P” part of the SOAP note being developed.

Query (243)

| | |
|---|---|
| “a. | If <2 risk factors and no CHD equivalents, ‘Based on ATP |
| | III, LDL goal = <160 mg/dl.’ If LDL ≧ 160 mg/dl’” (Show |
| | (a.) on P part of SOAP note if it is selected) |
| “b. | If 2+ risk factors and no CHD equivalents and 10-year risk |
| | 10-20%, ‘Based on ATP III, LDL goal is < 130 mg/dl.’” |
| | (Show (b.) on P part of SOAP note if it is selected) |
| “c. | If 2+ risk factors and no CHD equivalents and 10-year risk < |
| | 10%, ‘Based on ATP III, LDL goal is < 130 mg/dl.’” |
| | (Show (c.) on P part of SOAP note if it is selected) |
| “d. | If CHD or CHD Risk Equivalents present (from A:), ‘LDL |
| | Goal is < 100 mg/dl’” (Show (d) on P part of SOAP note if |
| | it is selected). |

Note how the guidelines are built into the prompts/options a to d to the user and then relevant SOAP note is automatically built and ready to go, also based on the guidelines.

P(245):

This part of the SOAP note is developed by the user choosing from the following selections (in quotations) by reviewing the selections and the notes (not in quotations) with the selections which are displayed to the user:

Query (246)

| | |
|---|---|
| a. | “Recommend initiation of therapeutic lifestyle changes |
| | (TLC),” and if LDL ≧ 190 mg/dl, “and recommend |
| | considering addition of drug therapy.” |
| b. | “Recommend initiation of therapeutic lifestyle changes |
| | (TLC) and recommend considering addition of drug |
| | therapy.” |
| c. | “Recommend initiation of therapeutic lifestyle changes |
| | (TLC),” and if LDL ≧ 160 mg/dl, “and recommend |
| | considering addition of drug therapy.” |
| d. | “Recommend initiation of therapeutic lifestyle changes |
| | (TLC), and recommend considering addition of drug |
| | therapy.” |

Note how even the recommendation choices are internally imparted with intelligence from the knowledge base to assist the user is selecting a choice.

F/U (248): The user selects from the options in the drop boxes (the calendar function of the PDA can be simultaneously used):

“Review therapy in”

(drop box)
“□ 1”
“□ 2”
“□ 3”
“□ 4”
“□ 5”
“□ 6”
(drop box)
“□ days”
“□ months”
“□ years”.

Text Pop-up (250):

This text can automatically be displayed, or alternatively could be user-selectable, to give the user some information and guidance from the guidelines:

“Therapeutic Lifestyle Changes to initiate if LDL is above

goal:

TLC Diet

Saturated fat < 7% of calories, cholesterol < 200 mg/day
Consider increased viscous (soluble) fiber (10-

25 mg/day) and plant stanols/sterols (2 g/day) as
therapeutic options to enhance LDL lowering

Weight management
Increased physical activity”

Again, the documentation implementor allows the user to be taken through a set of queries regarding the disease which are designed from and correlated to current guidelines. This prompts the user to follow the guidelines. The software also enters the answers to the queries into SOAP notes. It also can assist in qualifying and/or quantifying relative to the questions. But further, the software automatically develops/builds documentation (e.g. SOAP notes) from the prompted answers of the user. As can be appreciated by those skilled in the art, similar disease guideline documentation implementors can be developed for other diseases. Guidelines or recommended practices can be built in, like discussed above and autodocumentation can be used, as discussed above. It is to be understood that similar documentation implementors can be developed for other diseases, as desired or needed.

### Specific Example of Intervention Scoring (300)

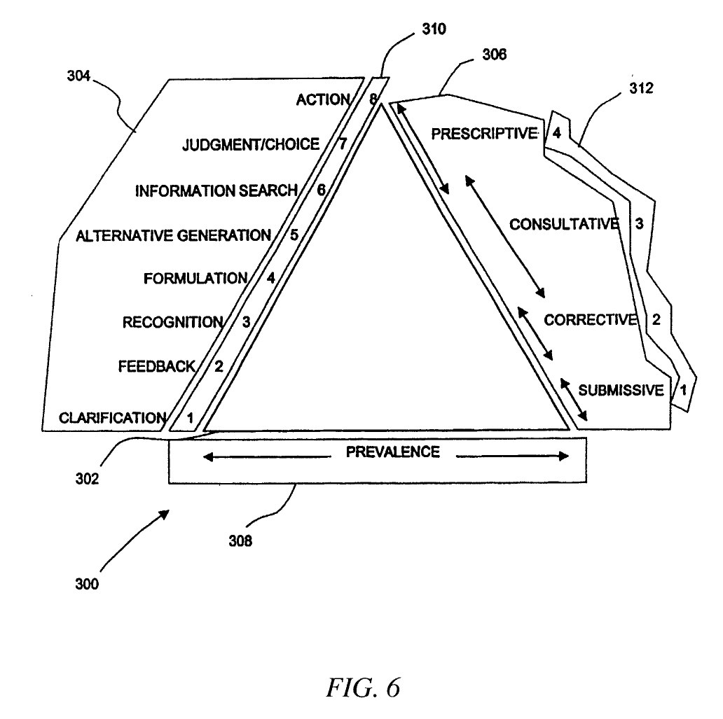

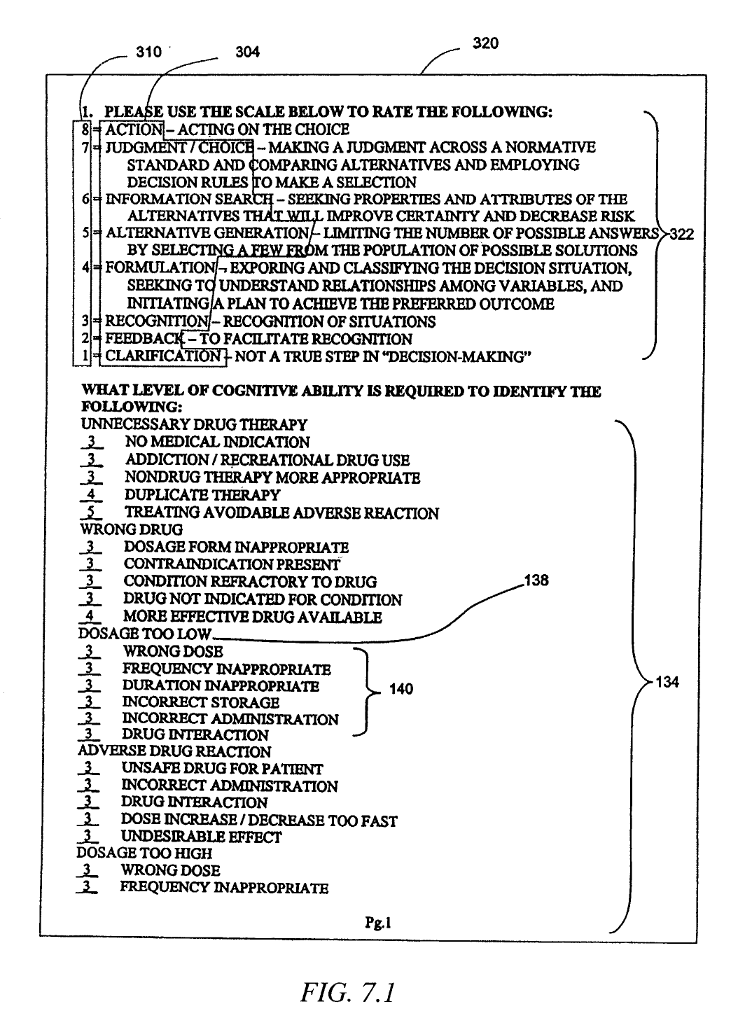

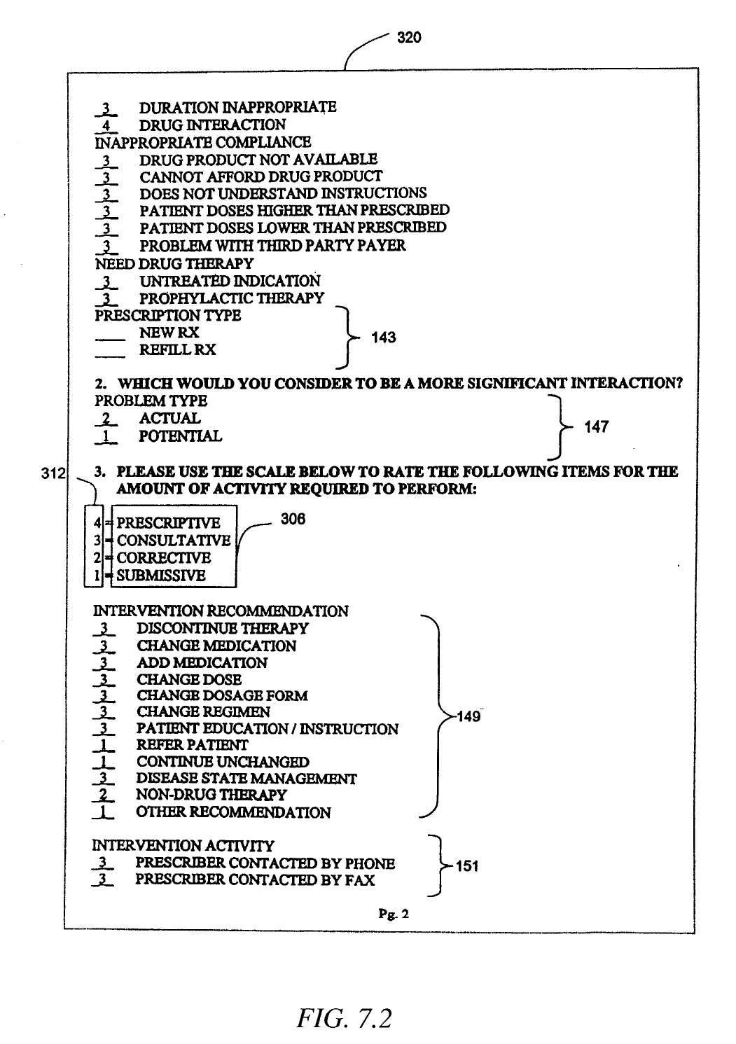

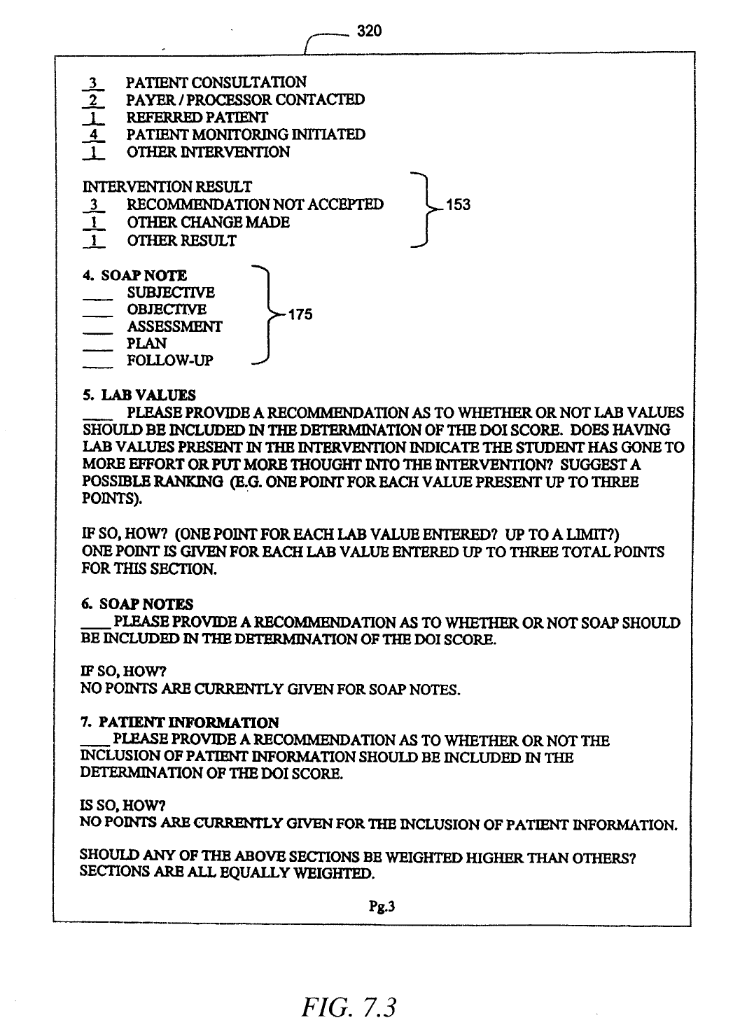

FIGS. 6 and 7.1-.3 illustrate in more detail the “intervention scoring” concept (300) according to the exemplary embodiment of the invention. As previously described, this method uses the Campagna model to establish an assessment of the amount of cognitive ability necessary to complete the documented intervention. It does not assess the intervention for correctness. The purpose of rating the intervention in this way is to get an indication of the performance of the student. It probes question like the following. Is the student mostly performing intervention that requires very little depth just to meet the quota of interventions that are required? Or is the student performing interventions that indicate that he/she has the capability to formulate interventions and make recommendations requiring higher cognitive complexity?

FIG. 6 illustrates the idea of the Campagna model, previously cited; namely the triangle (302) with the word labels “clarification”, “feedback”, “recognition”, “formulation”, “alternative generation”, “information search”, “judgment/choice”, and “action” on the left side (304) (bottom to top); the words “submissive’, “corrective”, “consultative”, and “prescriptive” on the right side (306) (bottom to top); and the term “prevalence” along the base of the triangle (308). Note that each of the labels on the right side are roughly correlated to one or more of the terms on the left side (see double ended arrows). Also, the double-ended arrow along the base of the triangle is meant to approximate the number of pharmacists who practice at the various levels (showing a decrease in frequency going from bottom to top of the triangle) as explained by Campagna in the incorporated-by-reference article.

This embodiment of the invention adds a scoring or quantification to this model. As shown in FIG. 6, each of the left hand Campagna labels is called a decision making step (304). A value (310) is assigned to each label, ranging from 1 to 8. Each right hand Campagna label is called a performance level (306) and likewise has been given an ascending value (312), here from 1 to 4.

The values in this example have been assigned increasing weight (or numerical value) for increasing (higher vertical) levels in FIG. 6. FIGS. 7.1-.3 illustrate a work sheet (320) that is used to then correlate the actions that a pharmacist or student might take in an intervention to either the decision making steps (304) or the performance levels (306) of FIG. 6. The work sheet (320) of FIGS. 7.1-.3 would be completed by one skilled in the field of pharmacy, e.g. a professor or practicing professional, relative to a particular intervention type. Alternatively, a plurality of persons skilled in the field of pharmacy could complete the worksheet (e.g. an expert panel), and those results averaged or otherwise applied to FIG. 6. FIGS. 7.1-.3 illustrate a worksheet 320 that has been completed.

Section 1 of worksheet (320) first includes a guide for the person(s) completing the worksheet, articulating the levels of decision making (304) and assigning a value (310) for each (from FIG. 6), as well as a word description (322) for each level of intervention. Thereafter, each of the listings from the “drug-related problem” screen (134) of FIG. 3.8 is set forth, each with an associated sublist of possibilities for such a problem.

For example, in FIG. 7.1, the “Dosage Too Low” category (138) from FIG. 3.8 has each of its options (140) from FIG. 3.9 listed. The expert(s) would assign a rating (304) to each of options (140) and would fill in the blank to the left of each category 140 with the corresponding preassigned a value (310) from FIG. 6. In this example, each of the options “wrong dose”, “frequency inappropriate”, “duration inappropriate”, “incorrect storage’, “incorrect administration”, and “drug interaction”, has been pre-ranked at value “3”, which corresponds to a level of intervention of “recognition”.

Similar assignments can be made for the other sublist choices for each general category of “Drug Related Problem) (136). Note, for example, some of the options under the category “unnecessary drug therapy” have been assigned either value “4” (for “duplicate therapy”) or value “5” (for “treating avoidable adverse reaction”). The expert(s) in this examples rank these as higher decision-making steps than the other three possible answers (“no medical indication”, “addition/recreational drug use”, or “nondrug therapy more appropriate”, all ranked at level 3).

Therefore, a skilled-in-the-field person or persons assign what level of the levels of FIG. 6 apply to the various types of actions prompted of the user during an intervention under the program of software 40. These expertly-assigned correlations have a point value based on the assignment of values 1, 2, 3, . . . 8 to the levels of FIG. 6. These correlated values can be placed in a database. When the user answers relevant questions which have values assigned, software 40 automatically, transparent to the user, assigns these “intervention score” values to the answers. The software 40 automatically accumulates the values as the user goes through the screens.

At the end of section 1 of the worksheet 320 of FIG. 7.1-.3, there are blanks for “prescription type”. If desired, e.g. if an expert or expert panel decides so, points or a value can be given for this, which relates to information prompted from the user at (143), see FIG. 3.10. Presently, no value is given.

A section 2 of worksheet 320 is shown at FIG. 7.2. It asks the expert(s) whether any points or values 1, 2, 3, . . . should be assigned to the type of problem involved in the intervention ((see choices (147), i.e. an actual problem or a potential problem). These are the same choices as the screen of FIG. 3.12. In this example, the expert(s) have given the value “2” for actual problem, and the value “1” for potential problem. This indicates an actual problem is given more scoring weight than a potential problem.

Next, in section 3 of worksheet (320), the expert or expert panel assigns a value between 1 and 4, corresponding to one of the performance levels 1 to 4 from FIG. 6, to each sub-option under each of general categories “intervention recommendations” (149 of FIG. 3.13), “intervention activity” (151) of FIG. 3.14. and “results” (153) of FIG. 3.15. Each sub-category is ranked or scored by the expert or expert panel according to what they believe is the appropriate level of performance (306) by placing a value 1, 2, 3, or 4 (312) correlated to that level in the corresponding blank to the left. In the article by Campagna incorporated by reference herein, he concludes performance level 1 is passive in nature, performance level 2 is corrective in nature, level 3 is consultative in nature, and level 4 is prescriptive in nature. These describe increasingly engaged or involved activities. In this example, each type of problem (147 from FIG. 3.12) is given a value from FIG. 6. Thus the rankings of scores 1, 2, 3, and 4 are increasing in value or more heavily weighted for the higher up the left side of the triangle in FIG. 6 the sub-category is ranked.

Here the expert(s) have ranked most “recommendation” options at performance level with the value or score of “3”. One (“non-drug therapy”) is scored at value “2”. The remaining three (“refer Patient”, “continue unchanged”, and “other recommendation”) are given a “1” value.

Optionally, other features or actions could be given a value. Examples are shown at sections 4-7 at the end of worksheet 320. In this instance, the expert(s) is/are first asked if any values should be assigned for (a) completion of and/or content of any parts of the SOAP note (175) of FIG. 3.21. Here (FIG. 7.3 at (175)), none are assigned. Also, a list of questions is presented to the expert or expert panel regarding whether or not “lab values”, “soap notes”, and “patient information” should be included in the determination of the scoring for depth of intervention. In this example, one point (value) is given for the lab values (see (163) at FIG. 3.19). But no points are given for SOAP notes and Patient Information at FIGS. 3.21 and 3.17 respectively. The experts can assign values to things, or adjust values, as he/she/they deem valid.

Thus, it can be appreciated that many of the sequential actions taken by a user of software 40 are rated relative to the levels of FIG. 6, the rating being weighted as to increasing decision-making involvement or performance level deemed to match the user's actions. In the background, software 40 accumulates the “score” for that user for that intervention.

A database can be created which has the pre-assigned values based on completed worksheet (320) stored therein. Software 40 can then automatically (or alternatively upon authorized request), calculate an intervention total score. An example is shown at FIG. 3.22 at (186). For the particular intervention illustrated at FIGS. 3.1 to 3.27, a total score of 16 was calculated by checking to see if the answers entered by the user for that intervention have an associated value in the database, and if so, adding up each individual pre-assigned value. From this accumulated score, the preceptor can immediately derive an idea of what type of actions the student took in the intervention. This can be compared to other scores by other students (or actual practitioners) for the same intervention, or otherwise can be used to help evaluate a student's performance. It can be used to judge the degree of influence the student had in the intervention. It can be used to judge the capabilities and talents of the student. This can also be reciprocated back to the curriculum by the faculty for review and enhancement. The score can be used as an indicator of the nature of the practitioner's actions in the intervention. It can be used to evaluate performance. It can be used to assess cognitive levels of the user's participation in the intervention. It can also be used to assess the user's amount of influence in the decision making processes that can take place in patient interventions.

The range of scores based on this exemplary embodiment is from 8 or 9 to 23 or 24, depending on which factors are scored. It is believed that a score of 12 or less indicates an intervention that would be considered on the lower scale of complexity; while a score of 19 or more indicates an intervention that would be considered on the higher scale of complexity. For example, lower scores indicate the user may be functioning only at a level of identifying and correcting obvious things, while a higher score may indicate the user is performing at a truly consultative level. This scoring is believed to allow a more objective way to evaluate, compare, and grade students or analyze practitioners. In this example, what might be called the linear nature of scoring (1, 2, 3, . . . ) was used. Scores for a number of different practitioners and/or students can be stored and evaluated, and it may be determined to adjust the scoring values.

As can be appreciated, aspects of this embodiment can be applied to other fields of healthcare, and can be used for self-analysis to help maximize performance of a practitioner or student for such field of practice and maximize the efficacy of treatment or therapy for the patient.

F. Summary of Advantages

It can therefore be seen that the above-described exemplary embodiment of the invention can advantageously be used in a variety of ways and contexts. Examples are as follows:

1. Academia

1.1. Teaching

1.1.1 Score grades/quantifies interventions—currently, grading is almost entirely subjective. This feature will help measure the level of cognitive effort required to perform the intervention and will be useful for establishing the depth of the student's understanding and abilities. Because the grading is subjective, there is variation across preceptors/faculty and students could possibly get by simply by performing the required number of interventions, but not perform quality interventions.

1.1.2. Reporting capabilities enable faculty to determine strengths and weaknesses of students. The faculty member will be able to do reports based on many factors, including disease, drug, etc. This will allow the teacher to assess if the student is strong across multiple areas or if the student is only strong in a few areas. Currently data is not organized in a manner that allows this.

1.1.3. Reporting capabilities allow faculty to use this information to assess curriculum by evaluating where students are and are not performing interventions. Through identifying areas where students are not performing interventions, the faculty can then go back to the curriculum to determine if there are teaching methods that need to be changed or if content needs to be added to facilitate learning. Currently there is no way to organize the data to do this.

1.1.4. Syncing capabilities enable faculty to assess interventions instead of preceptors. Currently, students do clinical rotations their last year of pharmacy school. Some of these rotations are overseen by college faculty and some are overseen by practicing pharmacists (preceptors). While these pharmacists are good practitioners, they have little, if any, teaching experience. Because of this, pharmacy colleges struggle to ensure good learning experiences occur at these sites. These syncing capabilities will enable the interventions to be sent to the college to be evaluated by faculty who have more formal training and experience in teaching.

1.2. Student

1.2.1 Makes it easier for students to record interventions so should increase the number of interventions performed by students. Currently, students record interventions on paper. At most schools, students then select one or two to do case study presentations on each week. At a few schools, students then take the paper form and input it into an internet-based form. Both methods are slow and time-consuming. The system will make it more convenient for students to record these interventions, likely increasing the number of interventions recorded.

1.2.2 Intervention scoring enables students to self-evaluate intervention. Because of the subjectivity of current evaluations, students sometimes become frustrated by being subjected to varying professional opinions or tendencies. The score will allow students to self-assess the level of their interventions across rotations.

1.2.3. The score could be used for class rankings. Much like law school, being able to quantify student interventions can allow for the development of class rankings. This will lead to increased competition and improve the learning of the students.

1.2.4. With the reporting capabilities, the scoring, and the electronic capturing of the interventions, students can assimilate interventions for portfolio and to be used for job interviews as examples of their work. Currently, there is no way to do this.

1.2.5. Disease guideline documentation implementors facilitate student learning and help ensure quality interventions through continuous access to current guidelines. Currently, students learn in the classroom and use reference books on rotations as provided by the site or that they have. The disease guideline documentation implementors will incorporate the current guidelines into their daily activities and practice experience. This will reinforce the guidelines and help the students to learn through repetition and active learning.

2. Independent Practitioner

2.1. Identify key stakeholder physicians through physician reporting—For independent practitioners, it is imperative for them to identify who their key stakeholder physicians are for their business. The reporting capabilities of this program will enable them to identify the prescribers that they are helping the most. There is currently no way for this to be done.

2.2. Provide reports to patients and physicians to establish pharmacy's value—Reports specific to patients and physicians will show the value the pharmacy is providing to ensure customer and prescriber loyalty. There is currently no way for this to be done.

3. General Potential Advantages

3.1. Reporting Functions

a. Drug

b. Disease

c. Intervention Scoring

d. Student

e. Prescriber

f. Patient

g. Site

3.2. Minimal Graffiti Entry

3.3. Multiple Syncing Capabilities

a. wireless-internet

b. PC database

c. PC-Internet

3.4. Patient Tracking

3.5. Possible Features

a. Lab value tracking will enable to show benefits of service.

b. Insertion of “Follow-up” into calendar.

4. Hospital

4.1. Allows data collection throughout hospital/health system. Pharmacists currently go on rounds through the hospital. In this decentralized format, they collect their data while away from the centralized pharmacy and then have to input it when they get back. This application will allow for the pharmacists to record their interventions and then either sync wirelessly while away from the pharmacy or sync when they get back to the pharmacy.

4.2. Estimated cost avoidance can be used to establish cost savings and FTE's—a feature could be an “estimated cost avoidance” feature which could enable the user to subjectively estimate the health care service prevented through the performance of the intervention. This will allow for documentation to justify staffing needs.

4.3. A possible feature to allow dosage calculations—another possible feature will be the addition of calculations specific to drug dosing and patient care.

5. Chain

5.1. Gives capability to gather data across multiple sites. Currently, most chain pharmacies' computer systems do not allow for data collection outside of the dispensing of medication. Most companies are also trying to move to “pharmaceutical care.” To do this, they need to be able to gather data to evaluate their programs. The only ways for them to do this is through email or paper forms. This is very time consuming and often has poor follow-through because of the time required to do this. With paper forms, data is sometimes not included for various reasons. Electronically, fields can be “required” to ensure the necessary data is collected.

5.2 Ensures service quality across multiple sites as it is “standardized.” One of the challenges of service delivery is that the service is highly dependent upon the deliverer of the service. For a chain company with multiple sites introducing new services, this can be especially difficult to monitor. Having a standardized system in place ensures the quality of the service across multiple sites.

5.3. Disease guideline documentation implementors—One of the challenges of professional practice is to get treatment guidelines into use in practice. Incorporating these “documentation implementors” into this application ensures the most recent guidelines are available at the point of intervention. Currently, these are only available through reference materials.

5.3.1. Ensure service quality—Building upon 5.2, to ensure the delivery of quality services across multiple sites it is also important to be sure that the deliverer is making recommendations using the most recent clinical recommendations. If they do not, patients are at risk, company and personal liability increases, and company and personal reputations are at risk.

5.3.2. Ensures staff is up-to-date with latest guidelines. Ensuring all of the staff across multiple sites are using the same, and most recent, clinical knowledge is very difficult. Currently the only control companies have over this is to provide continuing education and communiqués and memos for staff to read. The “documentation implementors” put the guidelines at the point of intervention to ensure they are being used.

5.3.3. Decreases data-entry time—Current documentation is very time consuming, mostly on paper. This drives up the cost of the service or decreases the amount of time that is spent with the patient.

5.4. Enables chain to standardize and quantify employee-pharmacist interventions for contracting with managed care. As pharmacies are introducing new services, they are trying to contract with third parties, such as managed care, for these services. Managed care has been slow to buy-in to these services because they have not seen the value established. This process and software application allow for data collection to establish the value. Currently, there is no easy way to do this.

F. Options and Alternatives

The included exemplary embodiment is given by way of example only, and not by way of limitation to the invention, which is solely described by the claims herein. It will be appreciated that the present invention can take many forms and embodiments. Variations obvious to one skilled in the art will be included within the invention defined by the claims.

The above exemplary embodiment has been described primarily in an academic environment. It can be applicable to actual practice of pharmacist. As illustrated in FIG. 1, software 40 could be used by independently practicing pharmacists. It could be used to improve patient interventions. It could be used for self-evaluation. It can be used for documentation purposes.

Similarly, FIG. 1 illustrates applicability to a plurality of users in a company (e.g. a pharmaceutical chain or chain of stores having pharmacies). The practitioners can use the software for similar advantages, plus for communication between each other, even at remote locations. It can instill standardization and uniformity of practice across the entity.

But further, the invention is believed to have applicability, at least in some aspects, to other healthcare practitioners and students. For example, the methodology of the disease guideline documentation implementors its believed to have applicability to other healthcare patient intervention functions, such as physicians and medical students, therapists, and others. FIG. 1 illustrates the analogous use of the invention by physicians 34. This could be other healthcare practitioners.

Still further, it is possible willing participants from any of these different entities in FIG. 1 would allow data to be integrated in a collective database for educational or medical purposes. For example, without giving away patient identity, such integrated data of many interventions might be used to help the practice of that field of health care. The results could be studied and may yield results that could advance the field.

The model described in the Campagna reference, incorporated by reference, is one way a model could be incorporated into an assessment system or method according to the invention. This pre-existing general model for pharmacists illustrates one example for that field. Other models, whether or not pre-existing, if deemed relevant and valid for a particular field and practitioner or student.

Software 40 can be written in a number of languages and ways to achieve the results and functions set forth herein. One example of portions of software 40 is set forth in the source code in the Software Appendix, appended to this document. The exemplary software program code listings comprise two separate programs. The first is for the actual patient intervention entry application. The second is for the synchronization component. The included code is specific only to Palm-type PDA's and syncing for that platform. Manifestations of these two programs would be different and unique for each computing platform.

What is claimed is:

1. A system for patient intervention assistance comprising:
(a) a personal computing device including an input component allowing input of data to the personal computing device, a display; and a storage medium for storing data;
(b) software operably loaded on the personal computing device which:
(i) presents on the display a set of queries related to a patient intervention;
(ii) presents on the display prompts to enter answers to the queries; and
(iii) automatically creates documentation of a patient intervention based on the queries and the answers.

2. The system of claim 1 further comprising a plurality of computing devices each having the software operably loaded thereon.

3. The system of claim 2 wherein further comprising a component operatively connected to the computing device to facilitate communication with another device.

4. The system of claim 3 wherein the said another device comprises one or more of a personal computer, a local server, or a remote server.

5. The system of claim 1 wherein the computing device is a PDA.

6. The system of claim 5 wherein the PDA includes A component adapted to synchronize data with another computing device.

7. The system of claim 1 wherein the computing device is a hand-held computer.

8. The system of claim 1 wherein the queries are questions presented in templates, the queries comprising relevant questions regarding patient intervention.

9. The system of claim 8 wherein the prompts include one or more of pull down lists, drop down menus, or other pre-created choices, and/or blanks into which can be filled free text.

10. The system of claim 1 wherein the automatic creating of documentation comprises a database into which can be stored documentation data in a pre-designed format.

11. The system of claim 10 wherein the data can be synchronized with a database in another computing device.

12. The system of claim 11 wherein the database can be accessible by another authorized party.

13. The system of claim 12 wherein the said another authorized party comprises a preceptor.

14. The system of claim 13 wherein the preceptor comprises a teacher.

15. The system of claim 1 further at least some of the queries being based on a knowledge base for a specific disease or condition.

16. The system of claim 15 wherein the knowledge base comprises recommended guidelines which are updateable by periodic updating of the software.

17. The system of claim 15 wherein the knowledge base is specific to a specific disease or condition.

18. The system of claim 1 wherein the form of documentation includes in the form of a SOAP note.

19. The system of claim 1 wherein the patient intervention is related to drug treatment or therapy by a pharmacist or pharmacy student.

20. The system of claim 1 wherein the software further allows evaluation of a patient intervention by applying a score to the answers to queries.

21. The system of claim 20 wherein the score for an answer to a query is weighted on the basis of the cognitive ability indicated by the answer relative to the query.

22. The system of claim 21 wherein the weighting is pre-created by an expert in the field of the patient intervention.

23. The system of claim 22 wherein the expert comprises a skilled person in the field of the patient intervention.

24. The system of claim 23 wherein the expert comprises a preceptor in the field of the patient intervention.

25. The system of claim 22 wherein the expert comprises a panel of experts in the field of the patient intervention.

26. A method for patient intervention assistance comprising:
(a) presenting on the display of a computing device a set of queries related to a patient intervention;
(b) presenting on the display prompts to enter answers to the queries; and
(c) automatically creating documentation of a patient intervention based on the queries and the answers.

27 The method of claim 26 further comprising a plurality of computing devices.

28. The method of claim 26 communicating the computing device with another computing device.

29. The method of claim 26 wherein the said another computing device comprises one or more of a personal computer, a local server, or a remote server.

30. The method of claim 26 wherein the computing device is a PDA.

31. The method of claim 26 further comprising synchronizing data stored on the computing device with data stored on another computing device.

32. The method of claim 26 wherein the queries are questions presented in templates, the queries comprising relevant questions regarding patient intervention.

33. The method of claim 26 wherein the prompts include one or more of pull down lists, drop down menus, or other pre-created choices, and/or blanks into which can be filled free text.

34. The method of claim 26 wherein the automatic creation of documentation comprises a database into which can be stored data in a pre-designed format.

35. The method of claim 34 wherein the database can be synchronized with a second database in another computing device.

36. The method of claim 34 wherein the second database can be accessible by another authorized party.

37. The method of claim 26 wherein the computing device is used by a student and said another authorized party comprises a preceptor.

38. The method of claim 37 wherein the preceptor comprises a teacher.

39. The method of claim 26 further comprising at least some of the queries being based on a knowledge base for a specific disease or condition.

40. The method of claim 39 wherein the knowledge base comprises recommended guidelines which are updateable by periodic updating of the computing device.

41. The method claim 39 wherein the knowledge base is specific to a specific disease.

42. The method of claim 26 wherein the documentation includes a SOAP note.

43. The method of claim 26 wherein the patient intervention is related to drug treatment or therapy by a pharmacist or pharmacy student.

44. The method of claim 26 further comprising evaluating a patient intervention by applying a score to the answers to queries.

45. The method of claim 44 wherein the score for an answer to a query is weighted on the basis of the cognitive ability indicated by the answer relative to the query.

46. The method of claim 45 wherein the weighting is pre-created by an expert in the field of the patient intervention.

47. A system for patient intervention assistance comprising:
(a) a personal computing device including an input component allowing input of data to the personal computing device, a display; and a storage medium for storing data;
(b) software operably loaded on the personal computing device which:
(i) presents on the display a set of queries related to a patient intervention;
(ii) presents on the display prompts to enter answers to the queries;
(iii) the set of queries being predesigned to be correlated to relevant guidelines for a selected disease, and
(iv) automatically creates documentation of a patient intervention based on the queries and the answers.

48. The system of claim 47 wherein the computing device is a PDA.

49. The system of claim 47 wherein the PDA includes a component adapted to synchronize data with another computing device.

50. The system of claim 47 wherein the queries are questions presented in templates, the queries comprising relevant questions regarding patient intervention.

51. The system of claim 47 wherein the prompts include one or more of pull down lists, drop down menus, or other pre-created choices, and/or blanks into which can be filled free text.

52. The system of claim 47 wherein the automatic creating of documentation comprises a database into which can be stored data in a pre-designed format.

53. The system of claim 47 wherein the patient intervention is related to drug treatment or therapy by a pharmacist or pharmacy student.

54. The system of claim 53 wherein the patient intervention is related to a medical treatment or therapy by a physician or other healthcare provider.

55. The system of claim 47 wherein the software further allows evaluation of a patient intervention by applying a score to the answers to queries.

56. The system of claim 55 wherein the score for an answer to a query is weighted on the basis of the cognitive ability indicated by the answer relative to the query.

57. The system of claim 56 wherein the weighting is pre-created by an expert in the field of the patient intervention.

58. A method of assisting a healthcare practitioner or student in patient intervention comprising: presenting a predetermined set of queries to the user, the queries correlated to relevant guidelines for a selected disease, and automatically documenting in standardized form the user's answers to the queries.

59. The method of claim 58 wherein the healthcare practitioner or student is a pharmacist or pharmacy student.

60. The method of claim 58 further comprising evaluating a patient intervention by applying a score to the answers to queries, wherein the score for an answer to a query is weighted on the basis of the cognitive ability indicated by the answer relative to the query.

61. A system for patient intervention assistance comprising:
(a) a personal computing device including an input component allowing input of data to the personal computing device, a display; and a storage medium for storing data;
(b) software operably loaded on the personal computing device which:
(i) presents on the display a set of queries related to a patient intervention;
(ii) presents on the display prompts to enter answers to the queries;
(iii) allows evaluation of the user by (a) creating a model including a hierarchy of possible levels of interaction; (b) assigning a value to said possible levels of interaction, each value correlated to a degree of interaction required for such interaction; (c) assigning a value to optional answers to queries in templates related to specific intervention types; and (d) summing the values for a documented intervention to calculate a combined intervention score; and
(iv) automatically creates documentation of a patient intervention based on the queries and the answers.

62. The system of claim 61 wherein the computing device is a PDA.

63. The system of claim 61 wherein the PDA includes a component adapted to synchronize data with another computing device.

64. The system of claim 61 wherein the queries are questions presented in templates, the queries comprising relevant questions regarding patient intervention.

65. The system of claim 61 wherein the prompts include one or more of pull down lists, drop down menus, or other pre-created choices, and/or blanks into which can be filled free text.

66. The system of claim 61 wherein the automatic creating of documentation comprises a database into which can be stored data in a pre-designed format.

67. The system of claim 61 wherein the patient intervention is related to drug treatment or therapy by a pharmacist or pharmacy student.

68. The system of claim 61 wherein the score for an answer to a query is weighted on the basis of the cognitive ability indicated by the answer relative to the query.

69. The system of claim 68 wherein the weighting is pre-created by an expert in the field of the patient intervention.

70. A method of evaluating the performance of a pharmacist or pharmacy student in patient interventions comprising: (a) providing a model including a hierarchy of possible levels of interaction; (b) assigning a value to said possible levels of interaction, each value correlated to a degree of interaction required for such interaction; (c) assigning a value to optional answers to queries in templates related to specific intervention types; and (d) summing the values for a documented intervention to calculate a combined intervention score.

71. The method of claim 70 wherein the model is a pre-existing model.
